(19) United States
(12) Patent Application Publication
(10) Pub. No.: US 2018/0103206 A1
(43) Pub. Date: Apr. 12, 2018

(54) MOBILE CAMERA AND SYSTEM WITH AUTOMATED FUNCTIONS AND OPERATIONAL MODES

(71) Applicant: Mobile Video Corporation, Broomall, PA (US)

(72) Inventor: Erlend Olson, Newport Beach, CA (US)

(73) Assignee: Mobile Video Corporation, Broomall, PA (US)

(21) Appl. No.: 15/854,664

(22) Filed: Dec. 26, 2017

Related U.S. Application Data
(63) Continuation of application No. PCT/US16/39325, filed on Jun. 24, 2016.
(60) Provisional application No. 62/185,355, filed on Jun. 26, 2015.

(51) Int. Cl. H04N 5/232; H04W 88/06; H04N 5/225

(52) U.S. Cl. CPC H04N 5/23258; H04N 5/2252; H04N 5/23267; H04W 88/06

(57) ABSTRACT

A system, device and method for conducting surveillance of activities, which is configured to autonomously capture of video of a scene being experienced by an individual, the device being configured to be supported on a user. The device includes components that capture and transmit video, and is configured to operate in a plurality of modes, including one mode where the device relays streaming video and at least one other mode or period mode where the device transmits a frame of a video image at a predetermined time interval. The device is configured to autonomously switch from one mode, such as, the period mode, to a live streaming mode of operation upon actuation based on a condition of a user or the user's environment. Embodiments of the device may be configured with a removable capture accessory that provides alternate scene viewing or recording options.

### CROSS-REFERENCE TO RELATED APPLICATIONS

This patent application claims the benefit under 35 U.S.C. 119 and 35 U.S.C. 120 of International Application Serial No. PCT/US2016/039325 filed on Jun. 24, 2016 and U.S. provisional application Ser. No. 62/185,355 filed Jun. 26, 2015, entitled “Mobile Camera and System with Automated Functions and Operational Modes”, the complete contents of which are herein incorporated by reference.

### BACKGROUND OF THE INVENTION

### 1. Field of the Invention

The invention relates to the field of mobile video systems, methods and devices for capturing and communicating information and scenes, and systems, methods and devices that provide information and may involve remote manipulation of devices. The devices, methods and systems automate responses to conditions and actuate features.

### 2. Brief Description of the Related Art

There are a number of circumstances where individuals are required to report and comprehend conditions of an environment and events taking place. In many fields, duties of individuals include the preparation of a record of observations and information which, in some instances, is in the form of a report. Often, reports will detail an event or a condition associated with an event. Typically, reports include images or other information that serves as evidence to explain or support the reported conditions. In some cases, an event may be taking place (such as an inspection of a building), while in other instances, the event may already have occurred (such as a hit and run accident scene). Examples of fields where reporting of observations is typically done include law enforcement, public safety, insurance adjustment, property appraisal, and home and commercial building inspection. In addition, the conditions of assets, such as, for example, a building or piece of equipment, as well as the movement of an asset or individual, may be required or important to know. For example, in some cases, an asset may exhibit a condition that may warrant a technician visit or inspection. One example is where a physical property is detected to have changed, such as, for example, a drop in pressure in a system, and maintenance is required. An individual generally may observe conditions and relay the observations through telephone or email. The technician also must observe the condition, but generally, the condition may be the result of an effect, since the cause may have occurred some time prior. In addition, although tracking numbers for items and other assets, as well as flight status information is generally available, when an item does not arrive, as expected, or at all, or an individual is not present at an expected location, it is often difficult to determine what may have taken place.

In many instances, after an event occurs, observations may only be available of effects generated from the event, leading to inferences and reconstructions of what actually took place.

In the case of law enforcement, these organizations have come to utilize ways to preserve evidence. Typically, a law enforcement officer engages in activities that generally involve the law enforcement individual as well as others, most notably, the public. Duties of law enforcement personnel involve enforcement of the laws and protection of citizens. Law enforcement officers often engage in responding to emergencies and threats to public safety. In a number of instances, law enforcement personnel encounter situations where the law enforcement officer must act quickly and decisively. In many instances, law enforcement officials are engaged in activities that involve protection of a citizen or group of citizens from harm, which often may include apprehending or pursuing an individual that is causing harm or threatening the officer or others. In many instances these threats and situations require an immediate response on the part of the law enforcement official. After an incident has taken place, where a law enforcement officer was required to act, such as, for example, carrying out an investigation, responding to a call, apprehending a suspect, charging a person with the commission of a crime or violation, or making an arrest, to name a few instances, the officer must issue a report, and detail the circumstances. Often, the report is done after the time of the incident, and, although it may be proximate in time to the occurrence of the event, the officer is required to provide a recounting of an event that has already taken place. In addition, there are witnesses that also give accounts of events. Regardless of whether an individual believes that their account is what they actually witnessed, there are likely to be conflicting accounts, and mistakes. In addition, there are instances where members of the public, as well as officers, may have differences in the observations that are reported. Evidence may be conflicting or not available, and, an officer or member of the public may be at a disadvantage after an incident has occurred, particularly where time has passed or other circumstances have intervened. Recalling specific details of events may be further difficult when attenuated in time, such as, for example, when a deposition, hearing or trial, is carried out.

A law enforcement officer generally must issue a report of an incident or activity, and, in many instances, cannot do so while the event is transpiring, but, rather must do so after the event. Surveillance by law enforcement of its own activities, the actions of others that the law enforcement individual is charged with protecting, as well as individuals that engage in, or are suspected of engaging in, unlawful behavior, is a useful way to ascertain information that may be useful as evidence to establish the circumstances of an event, and actions and conduct of those involved. In some jurisdictions, law enforcement agencies have relied on body worn cameras, which basically are worn by the users on their shifts to take and store video which may be uploaded after a user has completed the shift. These cameras typically include an actuation button that is depressed to commence recording of an event. Some recording may take place prior to depressing the actuator, and the pre event recording may be stored in a limited buffer provided that the actuator is depressed.

There are a number of occupations, in addition to law enforcement, where personnel have duties to observe, understand and report incidents. Among these occupations are, for example, private security officers, insurance adjusters and company safety monitors, and carriers of personnel and goods.

### SUMMARY OF THE INVENTION

A system, device and method are provided for conducting surveillance of activities. The system, device and method involve autonomous capturing of video of a scene being experienced by an individual. According to preferred embodiments, the system, device and method may be used in connection with the activities carried out by law enforcement agencies, and other first responders, to capture information, including video, sound, location and events, and stream the information to a command center. In addition, the system, method and device may be used in connection with field operations for other personnel, such as, for example, insurance adjusters, care givers, recipients of care (including in home or out of home services) and technicians.

According to some embodiments, the system, method and devices may be used in connection with an individual receiving care or services. The remote server may be configured as an operations center where a family member under care may be able to be identified and viewed by another family member. The device may be configured to be worn by the individual receiving care (or installed on or in connection with apparatus, such as a bed, pump or the like), and record periodic or live streaming video. The video and information may be available to a family member through the remote operations center, which receives information and video frames or streams from the device. Family members may be provided with access to the remote server or operations center and view the condition of the individual receiving care. The viewing options for the family member may include remote live streaming, historical video, or both.

According to one embodiment, caregivers may utilize the system, method and devices to record and report care conditions and monitor and track tasks performed. The devices may be utilized by a caregiver, and may be configured to receive information and data from a patient, and other patient related monitoring devices, and transmit that information along with video to the remote server. In addition, the device may be configured to record video when a procedure is carried out, or when a patient receives a treatment, food, drug or other service. The caregivers may use the device to record treatment administered.

According to one embodiment, the system, method and devices may be implemented for use where technicians are at a site or location, and a command center may receive remote information and video of the condition that the technician is addressing. The devices may be implemented in connection with the repair of an asset, such as, for example, a machine or apparatus. An adjuster may utilize the device to provide a live report to a command center where a condition is observed and recorded along with information useful in evaluating potential remediation or valuation.

The system, method and device also may be configured to allow operation of the device or one or more of its operation features to be actuated remotely from the command center, or from an operations center, or from an individual who is concerned about a family member or friend via a server dedicated to the purpose of this function.

Systems, devices and methods are provided for capturing, recording and streaming live video and audio from a location of a user to a remote location. When video is referred to, preferably, audio also is included. According to preferred embodiments, a device configured as a mobile camera is provided to record events and communicate information, including live video, to a remotely situated component at a remote location. The system, method and devices may be used by law enforcement, public safety, emergency personnel, first responders and others. In addition, the device, system and method may be configured for use in connection with insurance adjustment, real estate or property inspections, as well as personal care management of an individual or patient of a facility. The device, system and method may be implemented in conjunction with asset monitoring, and may be utilized in connection with the movement of an asset, or of an individual traveling. The asset or individual in transit may utilize the device to provide information and video to a remote server. For example, where an individual is traveling from a first location to a second or destination location, the device may be configured to transmit video frames or live streaming video to a remote server. The remote server may be accessed by authorized individuals or devices, to view the location and other information, as well as video frames or streams, of the traveling individual and the surroundings.

Additionally, for example, conditions of an asset, (e.g., a building or piece of equipment) or person, as well as movement of an asset or individual, may be determined through tracking. Series of events may be observed through recording or streaming of information, including live video or a video frame, so points in time may be preserved or provide alerts when observed. For example, in some cases, an asset may exhibit a condition that may warrant a technician visit or inspection. One example is where a physical property is detected to have changed, such as, for example, a drop in pressure in a system. The technician may view real time information and video, and, also may view temporal video to ascertain when the event took place, and observe captured video of the nature of the event. In the situation where the occurrence is ongoing, the technician may view the event remotely, such as, for example, from a remote server or remote device. There may be, as well as events such as, for example, monitoring an asset, monitoring the location of a family member who is traveling or in transit, as well as monitoring of the family member who is at a location other than that person's customary location.

According to some embodiments, one or more features of the device may be controlled remotely, such as, for example, the camera orientation or direction. An authorized individual may view the video stream or frames and may operate the camera by manipulating the lens or other component to view images from a different direction. The device may be supported on the body with a harness or other suitable attachment mechanism, and, according to some embodiments, may be supported by or on the clothing of the user or on something associated with the user, such as a backpack or a means of transportation.

Preferred embodiments of the device are configured with a removably detachable capture accessory. For example, a removable capture component, such as, for example, a camera with a lens, is provided. The capture accessory may be removed from the device body so that alternative capture accessories may be installed on the device, as needed or required. For example, embodiments of the capture accessory include stereoscopic lenses, zoom lenses, movably selectable viewing fields, and low light viewing components that may include infrared sensors and circuitry.

According to some embodiments, the capture accessory may include an image sensor on which the image directed thereon is captured. According to some alternate embodiments, the device may include an image sensor, and the capture component may be configured to direct the image onto the image sensor provided in the device. According to some alternate embodiments, a capture accessory may be provided with an alternate image sensor, which may be in addition to an image sensor provided in the device body. A capture accessory may be provided to include a higher resolution image capability, such as, for example, high or ultra-high definition (ultra HD or UHD). The capture accessory may be replaced or upgraded, for example, where UHD is desired.

Alternatives for the capture accessory also include embodiments where a plurality of lenses are provided, such as, for example, to provide capabilities for obtaining an image from multiple directions.

The capture accessory may include components that may be operable from a remote location, such as, for example, from a command center with which the device may communicate through a network. For example, the capture accessory may include a zoom lens, which may be operable from the remote server or command center, to zoom in or out of a scene, as video is being streamed and viewed from the device.

The device preferably may function in a plurality of operation modes, and, may be actuated to commence or switch to a mode of operation, upon a triggering event. The device preferably includes one or more sensors to sense conditions, including conditions that may be associated with events, such as, for example, explosions, loud noises, bright lights or sirens, special voice commands, discharge of a weapon, change in the dynamics of the user (e.g., running, climbing, yelling, and the like) or of another nearby. Embodiments of the device also may monitor a user's physical conditions, such as, for example, a user's body functions (e.g., heart rate, respiration), and may actuate a mode of operation based on a user body function. For example, a user heart or respiration rate that is outside of parameters, may be detected, and processed to implement actuation of a live video streaming mode.

According to preferred embodiments, the device is configured to communicate through a network. The network may be any suitable network, such as, for example, cellular, radio, 2G, 3G, 4G, LTE, satellite, RF, as well as through Wi-Fi, WiMAX, microwave, and other communication means. According to preferred embodiments, the device is configured to communicate using multiple networks, so that where a device detects a signal of an available network, it makes a remote connection to a remote component, such as, for example, a command server. The device may be provided to communicate according to one or more configurations. According to one exemplary embodiment, the device communicates using a first configuration or mode where the device transmits information (e.g., user and device ID, and location) and a frame of video at a preset time period (e.g., 1 frame per second, 1 frame per minute). The device also is configured to communicate using a second configuration or mode where the device transmits a stream of information and video. The communications preferably are received by a command center, which may include a server that the device communicates with through a network. The device preferably is actuated to switch between modes of operation upon a condition or event. The actuation, according to preferred embodiments, is autonomous upon the commencement of a triggering event. Alternatively, the device modes may be controlled by the device user, and, according to some embodiments, the command center may disable the user ability to switch or use a particular mode.

The device preferably is configured with security encryption, which may include encryption for accessing functions of the device and for storing information, as well as encryption for transmitting information from the device. The network over which the device communicates to receive and transmit information also may provide additional encryption for the data and information being transmitted from or to the device.

According to some preferred embodiments, the system, device and method may include a command center or server, which is remote from the location of the device in use. The command center may be configured as a server having a hardware processor, software with instructions for instructing the processor to manipulate data, and a communication component for engaging in communication between the server and the device. The server may communicate with a number of devices. The device and remote server may communicate through any suitable network. The device and/or certain functions thereof may be operated remotely at the server. The server may be configured with software containing instructions for operating the device. Commands, for example, may be issued to the device to regulate the mode of operation (single-frame rate or streaming of video), to limit the usage of network bandwidth by a device, to stop the device from transmitting or alternatively to cause the device to transmit to the server. The server also may be configured to operate mechanisms of the device that are associated with features of the device, such as, for example, controlling the lens of the device to zoom in or out of a scene, changing the orientation of the view direction, selecting a transmission rate or limit. According to some embodiments, the server also may power on or power off a device, as necessary. According to some embodiments, the server may be configured to control a device that has been temporarily instructed not to transmit (e.g., by a user operation). For example, where a device is placed in a privacy mode to prevent the device from transmitting for a limited time, the server may override the privacy mode, and cause the device to transmit. This may be desirable, for example, where an event is taking place nearby the location of a device, and the device, while indicated to be off, needs to be on to record the scene. According to some embodiments, indicators also may be provided on the device to indicate a condition of the device or its operation, such as, recording, transmitting, under server control. According to some embodiments, server control of a device may deactivate some or all of the indicators to allow for stealth monitoring and operations. According to some embodiments, when the device is placed in the stealth mode, certain features may be disabled, such as, for example, any movements of the device or its accessories (such as, for example, motors, mirrors, lenses, and the like).

The device includes sensors that are provided to detect events and regulate operations of the device. In the case of law enforcement personnel and first responders, often there is no time to initiate actuation of a device or change settings upon being engaged in an event. The device preferably is configured for autonomous actuation in circumstances where an individual may be unable to actuate or operate the device. For example, some other circumstances which are not likely to allow for a user to manually actuate a device or feature thereof include, for example, when an individual is under pressure or a constraint, such as being the victim of a crime (e.g., like a shop owner being robbed or a child being abducted). In these circumstances, the device sensors provide information to detect a condition or change in a condition and autonomously actuate the device to record and store information and video, or to transmit video and information to a remote server, or both. The device is configured to sense conditions and actuate a mode of operation in response to a triggering condition. For example, where there is a loud sound, such as, an explosion, the device, if not already in streaming mode, may be actuated to stream information and video, including video that was being captured prior to the event on a rolling basis. For example, an unusual movement by an individual, a physical condition (heart or respiration rates) may be detected by the device. The detection of a triggering event may actuate the transmission of streaming information and video. The video stream and other information (e.g., device information, condition or action causing the implementation of an operation mode) may be communicated to a remote server. The device also may be provided with sensors configured to actuate upon an operation of a user's vehicle. For example, where a user is a police officer, and the police car siren is sounded or lights are turned on, the device may commence operation in either a recording mode, or a live streaming mode, and operate to transmit live video to the server. According to some embodiments, the device may record locally in the first mode, and a video frame is recorded per set time interval, (e.g., 1 frame per second, one frame per minute). Upon encountering a condition or triggering event, the device may be automatically actuated to switch from the frame mode (sometimes referred to as the period mode or heartbeat mode) to a recording mode or a live streaming mode where live video is streamed in addition to being recorded.

According to preferred embodiments, the device records video and saves the video to storage media, which may comprise one or more storage elements on the device. There may be removable storage media (e.g., such as an SD card), and the device also may include an internal storage for backup (e.g., such as a hard drive, solid state drive, flash or other memory component). In the event that the device user is recording and streaming, and enters a location where the wireless network is inoperative, the device may continue recording and save the scene video image and audio (and other temporal information) to the internal storage of the device (the removable storage card, backup storage media, or both). According to a preferred embodiment, the device may be configured to mark the video location where the network was inaccessible or cut out. When the device regains communication with a network, the device may stream the live video from the current scene. According to some embodiments, in addition, the segment of video and information that was captured during the time when the device was not communicating with a network may be streamed. According to a first embodiment, the server receives a live stream, and has the option, upon receipt of the segment stored during network inactivity, to view the segment. According to an alternate embodiment, the server may view the live streaming video being sent from the device and may simultaneously view the segment. According to a second embodiment, the streaming may continue, with the segment from when the network was not connected, provided from a memory buffer of the device (or other storage), and a continued buffer of the current video following the segment. The server may be configured to increase the frame rate for the buffered segment and other video (current capture), until the server viewing catches up with the device stream.

Sensor actuation may implement transmission from the device, and some examples of the sensor actuation to activate the live stream mode of operation may include temperature, sound, shocks, altitude, speed, acceleration, and location. The device actuation of the second mode, which is the live streaming mode, may be based on associated signals from sensors, including, for example, one or more sensors that detect movement, altitude, vision (e.g., light), sounds, atmosphere components (such as, for example, chemicals or fumes), temperature, moisture. According to some embodiments, the device may operate in a mode where the device records continuous video. The device may store the recorded video to local memory or may stream it to a remote server, or both. Device operation and conditions may determine whether the continuous recorded video is streamed to a remote server, and the streaming mode may be actuated to implement autonomous streaming. Additionally, the device may be configured to automatically record continuous video to the local memory whenever there is a loss of connectivity between the device and the server or the device and the wireless network.

The system and device may include additional accessories that facilitate providing and collecting information. For example, in the case where headgear, such as, for example, a helmet is worn by a device user, the device may include accessories for the helmet, such as, a camera or sensor that attaches to the helmet. The additional accessory, such as, for example, helmet accessories, may connect directly to the device, through a wired connection, or may wirelessly connect, such as, for example, using radio or other types of transmissions, e.g., an ISM band, 2.4 to 2.485 GHz, spread spectrum, frequency hopping, full-duplex signal, or other suitable types of transmission. Alternatively, sensors may be provided to detect physical conditions of the user, such as, for example, the user heart rate, or an increased heart rate, the user's respiration rate, the user's temperature, or other characteristics of the user's physical state.

Embodiments of the device preferably include a macro video stabilization feature that stabilizes the apparent video. The device may be used by an individual or in connection with an element in motion. Consequently, movement of the device, such as, for example, where it is attached to an individual who is moving (e.g., running or riding a bicycle), will change the location from which the video is taken and directed to the camera. This will result in the appearance of movement as if the scene is moving or shifting, and for the viewer, may be difficult to follow. The device preferably is configured to “macro-stabilize” the apparent video, such as, for example, when the device is worn on the body of a user and the user is running or riding a bicycle. The device is configured with sensors and, upon detecting the motion activity, actuates a stabilization mode.

According to a preferred embodiment, the stabilization mode involves optical stabilization of the device components. According to a preferred embodiment, the device is provided with an image sensor for capturing an image. The image sensor in some embodiments is provided in the device body and in other embodiments may be provided in a removably associated component that may attach to and detach from the device body, such as, for example, a removable capture accessory with a lens.

According to some preferred embodiments, the stabilization mode of the device, when implemented, optically has the image sensor enter a mode where each frame of the video is selected from a larger sensor frame, such as, for example, an HD frame out of a UHD size sensor, such that there are two time constants associated with the stabilization mode. One time constant is rapidly responsive and selects frame-by-frame a smaller frame of video out of a larger sensor frame to eliminate the movement of the wearer which is due to the activity such as running, while a longer time constant in the algorithm allows for general changes in the direction of the apparent intended field of view, such as, for example, when the wearer is making a turn in direction on purpose. The stabilization feature is designed to allow for allowing the capture of a scene where the device movement is the result of purposeful movement of a user, such as, for example, a turn in direction, while stabilizing the video frame with regard to movements where the camera motion is incidental to the activity, such as when the user is running (and the device or capture component is shaking).

According to preferred embodiments the device may be configured to operate in a one of a plurality of image framing modes, where the device capture may change the selection of the image frame. According to some embodiments, the device may capture video on the sensor filed area, or a smaller portion of the sensor field area. In one mode of operation, the device captures frames of video on the sensor field, which are smaller than the sensor field. In another mode of operation, the device captures video using the full frame of the sensor field area. The device also may capture video using a full frame that is less than the sensor field area. Smaller frames may be taken from the larger field (i.e., the sensor field area or full frame). The device may be configured to autonomously switch between capture modes. For example, where a device condition senses a movement that requires stabilization, the device capture mode that is the smaller frame capture mode may be implemented. The stabilization mechanism of the device is configured to reduce or eliminate undesired movement (e.g., from a shaking motion) by utilization of the frame-field stabilization mode (FFSM), where a smaller frame is captured of the larger sensor image field area or full field area. Implementation of the stabilization mechanism, and the frame-field stabilization mode may be done when the device senses a triggering movement condition.

According to preferred embodiments, the device preferably may be configured to trigger a mode of operation when the device is in a particular location. The triggering location may be a designated location that is defined by GPS location coordinates of the device location matching a designated location at or within which it is desired to have particular device operations actuated (e.g., increasing the recording rate, transmission rate, or both). For example, one trigger can be when the GPS coordinates are within a certain distance of a target list of GPS coordinates, or within the bounding shape of a set of coordinates. Where the device is inside the bounding shape, including a bounding circle or box or other shape artificially generated by the specification of one or more points and an associated shape, one example being a central point and a radius, and other examples including a central point and a square (i.e. square blocks), or, another example is a simple list of points which are assumed connected, the device records video, and/or the heartbeat information rate increases (i.e. from once per minute to once per second), or other device feature is actuated. For example, where a law enforcement or military person using the device is on an operation (such as, for example, a drug bust, or counterinsurgency operation) then the device video commences recording automatically on approach.

Another example of the utilization of a device boundary is where the device user enters a particular area where others have an interest. For example, a command center operation or personnel may have an interest in an area in which a law enforcement officer enters. The interest may desire the location boundary, and the device may operate to provide greater information, such as the rate of the information, sending, and video (e.g., the image rate (video) increase). The device may commence recording at the higher rate, and transmission of video may commence, if it is not already being transmitted, or proceed at a higher rate. The device video rate increase and transmission occurs based on the device being in the designated location area or zone.

Conversely, the device may be configured to engage in a mode of operation when the device is not within a particular defined boundary. The device location, when within a boundary, may operate according to one operation mode or sequence, and when the device is outside of a boundary, another mode of operation may be implemented. For example, the device may trigger an operation so that the video and/or more detailed recording of parameters occurs only when the body camera goes outside of the bounding area. For example, a child may wear the device on the child's neck or on a backpack. When the child is walking home from school with the device, so long as the child is on the proper route, then the device transmits a heartbeat (e.g., a frame every minute). However, when the child strays outside the prescribed path, the device is actuated to operate in a mode to provide increased information. For example, the increased information mode preferably, implements recording of video (e.g., a frame per second, or higher rate), and the transmission, if sending a frame every minute, may continuously transmit the information, including the video, sound, location and other information that the device may provide.

The device, system and method may be configured to have increasingly, progressive triggers, so as to escalate the recording and transmission of information and video as events occur. For example, the device, system and method may be configured with a multiple-layered trigger. Information may be obtained by the device, including, information obtained from device sensors, the device camera, locating chips, and other device components. The device may be configured to provide information pursuant to an information rate. The information rate, preferably, is regulatable, and may be automatically regulated based on the device location. For example, increasing the information rate may increase the amount of information obtained by the device sensors and cameras, and may increase the amount of information transmitted from the device.

The device location may determine the rates of information and transmission. The information rate may be video frame rate, or data obtained from the sensors. For example, where information rate may involve information that is image frames, or video. The video captured by the device, for example, may result from the increase of information, either transmitted from the device, or recorded by the device, where the information is more and more often, for example, from a single frame every 2 minutes, to, for example, a frame and heartbeat information every 10 seconds, to full motion 30 fps video. The device may be configured to increase the rate of any information being obtained from the device sensors or that is captured by the image capturing components, as well as the rate of transmission of that information from the device. Examples of information may include video (i.e. wherein a frame rate of captured scene frames increases until it is video), or may increase from a heartbeat, that obtains and transmits information conditions of the user or user environment (e.g., a radiation reading, or any other condition or movement that the mobile device is configured to sense), to continuously increasing readings.

According to some alternate embodiments, the image sensor is movably provided, and, is movable along a vertical or horizontal path, such as, for example, over an x,y coordinate plane.

Features discussed in connection with the device, system and method, may be provided together, separately, or in combinations with each other, in one or more device or other system components, such as, for example, the remote server.

### BRIEF DESCRIPTION OF THE DRAWING FIGURES

FIG. 1 is a perspective view, looking at the front from the right side, of a first embodiment of a mobile field image recording device.

FIG. 1a is a perspective view showing the housing of the device, without the capture accessory, and separate from the other components of the device.

FIG. 1b is a perspective view showing the rear housing cover looking into the interior thereof.

FIG. 1c is a perspective view showing the exterior rear housing cover, as viewed looking from the bottom.

FIG. 1d is an exploded perspective view of the housing of FIG. 1a.

FIG. 1e is a front elevation view of the device, shown separately from the capture accessory.

FIG. 2 is a front elevation view of a detachable accessory of the device of FIG. 1, shown separately from the other components, the detachable accessory being configured as an image capturing component.

FIG. 3 is a front elevation view of an alternate embodiment of a detachable accessory configured as an alternate image capturing component.

FIG. 4 is a front elevation view of an alternate embodiment of a detachable accessory configured as an alternate image capturing component.

FIG. 5 is a right side perspective view of an alternate embodiment of a detachable accessory configured as an alternate image capturing component.

FIG. 6a is a schematic illustration of an exemplary embodiment depicting device components.

FIG. 6b is a right side sectional view of an embodiment of the device shown in FIG. 1e, taken along the section line 6b-6b of FIG. 1e.

FIG. 6c is an enlarged sectional view taken from the encircled area 6C of FIG. 6B.

FIG. 6d is an enlarged sectional view taken from the encircled area 6D of FIG. 6B.

FIG. 7a is a schematic illustration of the device of FIG. 1 and a charger, depicting a wireless charging arrangement.

FIG. 7b is a horizontal sectional view of an embodiment of the device shown in FIG. 1e, taken along the section line 7b-7b of FIG. 1e.

FIG. 7c is a partial sectional view taken of the encircled area in FIG. 7b, as represented by the broken line projection 7c in FIG. 7b.

FIG. 8 is a perspective view, looking at the front from the left side, of the device of FIG. 1, shown with an alternate embodiment of a detachable accessory configured as an alternate image capturing component.

FIG. 8a is a left side sectional view of the device and capture component of FIG. 8.

FIG. 9 is a schematic illustration depicting an exemplary arrangement of a video imaging and information surveillance system of the invention implementing the devices according to the invention, and shown operating with a command center.

FIG. 10 is a front elevation of an embodiment of an image sensor chip showing an image area.

FIG. 11 is a front elevation of an embodiment of an image sensor chip showing an image area, and small frame depictions.

FIG. 12 is a schematic illustration depicting a location boundary operation of the device.

### DETAILED DESCRIPTION OF THE INVENTION

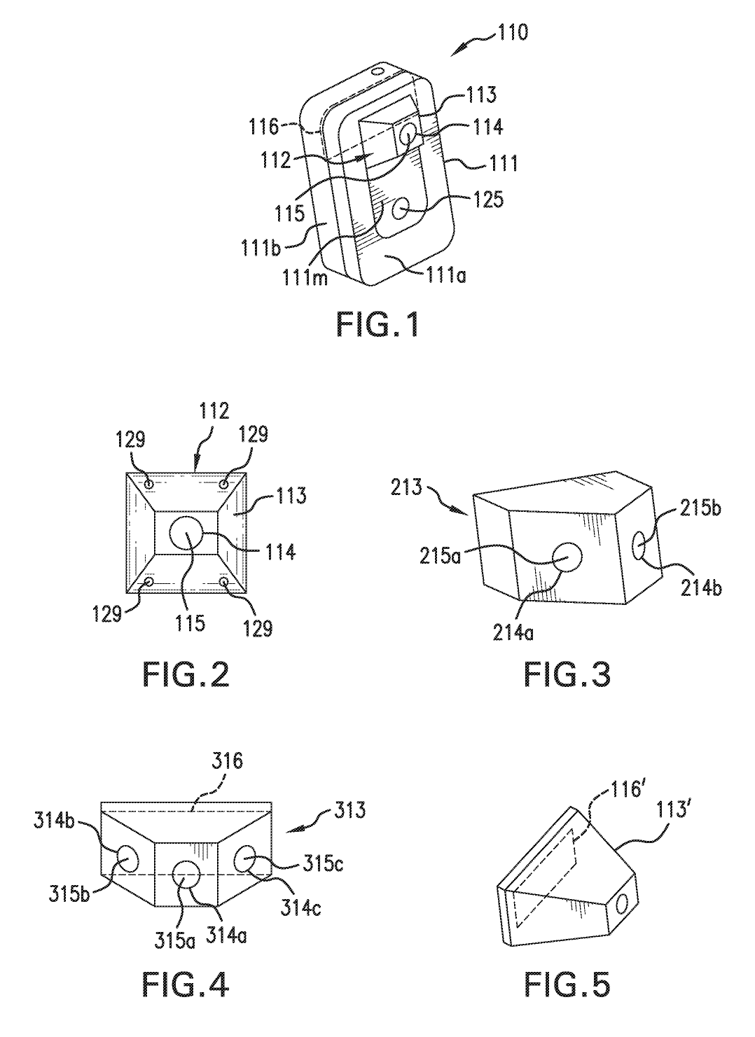

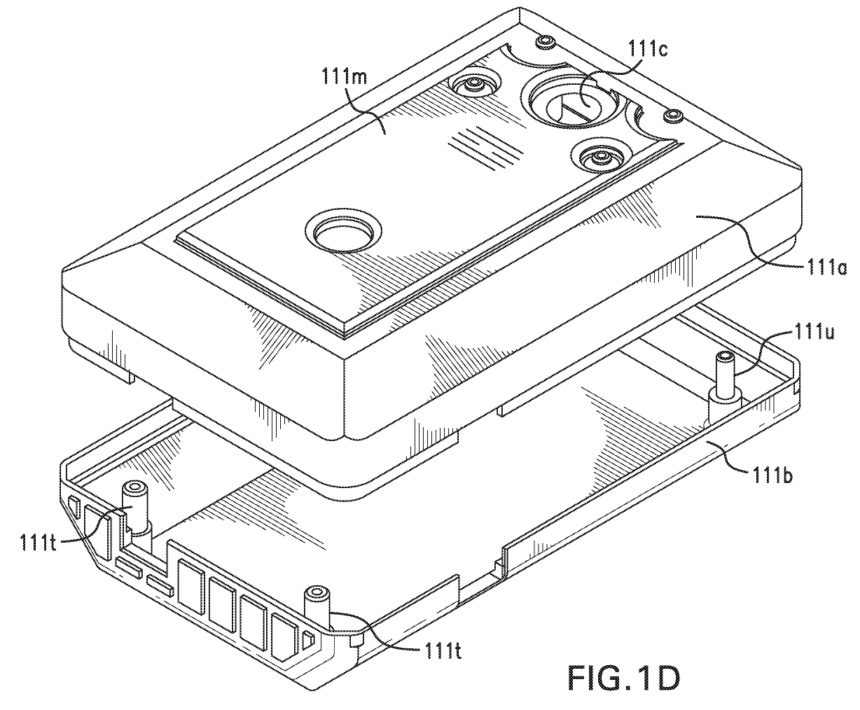

A system, method, and device are provided for conducting surveillance of activities, and include mechanisms for autonomous capturing of video of a scene being experienced by an individual. Referring to FIG. 1, an exemplary embodiment of a mobile camera device 110 is illustrated. The device 110 is shown having a main body or housing 111 and a removably detachable accessory 112. According to a preferred embodiment, the removably detachable accessory 112 is configured as a capture component 113 having one or more camera elements. According to the embodiment illustrated, the capture component 113 includes an opening 114 through which an image may be recorded, and, more preferably, a lens 115 is provided at or in proximity to the opening 114. The lens 115 preferably is supported on the capture component 113. The device 110 also includes an image sensor which may comprise a sensor chip 116 disposed along a path of the lens 115 for receiving an image that the lens 115 directs thereunto. According to some embodiments, the image sensor or sensor chip 116 may be disposed within the housing 111. According to alternate embodiments, an image sensor or chip 116′ may be provided in the capture component 113′ (see FIG. 5). Alternatively, the device 110 may include an image sensor or chip 116 and the capture component 113 also may be supplied with an image sensor or a sensor chip 116′. According to some embodiments, the device 110 may be provided with a first type of sensor chip (e.g., an HD resolution chip), whereas, a capture component 113 may be provided with an alternate sensor chip 116′ having one or more alternate features (e.g., an ultra HD chip, infrared circuitry). The removably detachable accessory 112 may be utilized to provide upgrades to the device 110, such as, for example, an upgraded camera, an alternate lens option (remote zoom, infrared, multi-lens imaging, stereoscopic, panoramic, and the like), or other alternate feature, such as, for example, an alternate sensor chip, such as the alternate image sensor or chip 116′. According to some alternate embodiments, the sensor chip 116 may be provided as part of the capture component 113. Some embodiments may provide a device 110 which does not have the sensor chip therein, and relies on the capture component 113 to provide a sensor chip via attachment to the device 110. According to some preferred embodiments, the image sensors 116,116′ (as well as the sensor 316) are configured with a chip and may include circuitry for relaying signals from the chip for processing by a processor of the device 110. According to some alternate embodiments, the image sensor circuitry may be configured to include a separate processor, or microcontroller.

The device 110 preferably is configured to be worn on the body of a user, and may be secured to the user using a suitable harness or other mounting mechanism (not shown). According to some embodiments, the device 110 may attach to the user's clothing, or other articles or accessories worn by the user.

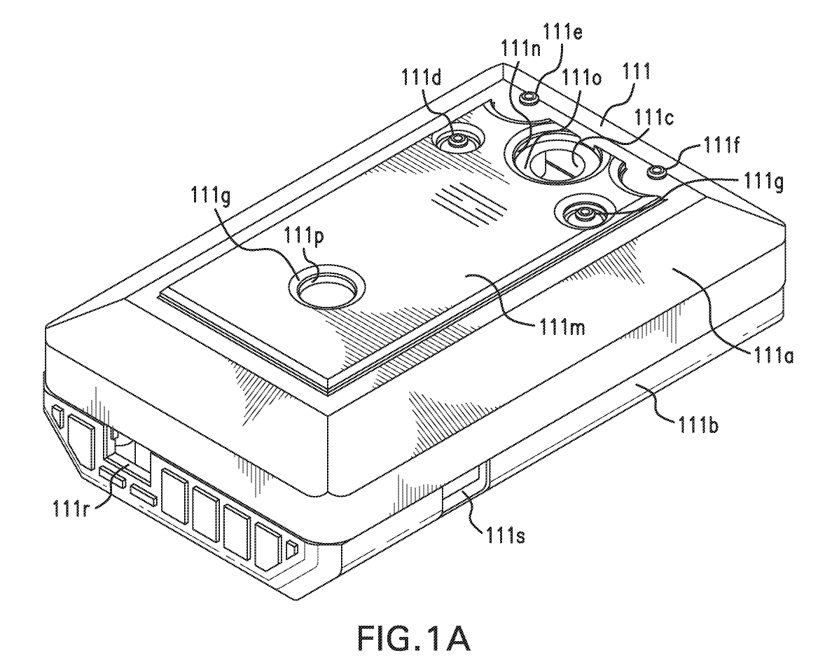

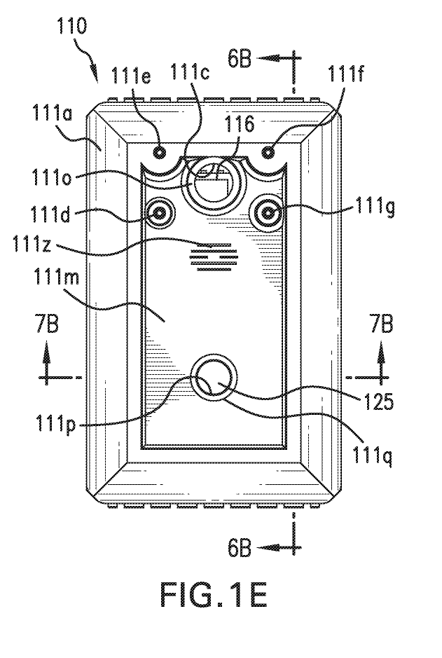

Referring to FIGS. 1a, 1b, 1c and 1d, a preferred embodiment of the device housing 111 is shown including a front cover 111a and rear cover 111b. The front cover 111a has an opening 111c therein, which preferably aligns with the opening 114 of the capture component 113 when it is installed on the device 110. The housing includes mounting bosses 111d,111e,111f,111g for facilitating mounting of the detachable accessory 112 onto the housing 111. According to a preferred embodiment, the mounting bosses 111d,111e,111f,111g include respective apertures 111h,111i,111j,111k, which are matingly associated with mounting elements of the detachable accessory 112. In the embodiment illustrated, the detachable accessory 112 is configured as a capture component 113. According to a preferred embodiment, the apertures 111h,111i,111j,111k may be threaded or contain a threaded element therein for receiving a matingly threaded fastener, such as a screw 129 (see FIG. 2). The housing front 111a preferably includes an upper pad 111m. The upper pad 111m includes an annular flange 111n that defines a recessed area 111o surrounding the opening 111c. A second opening or lower opening 111p is provided in the housing front 111a, and preferably in the pad 111m. An actuation button 125 (see FIG. 1), may be accessed through the opening 111p. A beveled edge 111q is shown provided around the opening 111p. The housing 111 preferably has one or more ports 111r,111s for connecting accessories, such as, for example, power connections (power cords or chargers) and connections to access the data, such as for uploading data from the device, or installing updates, such as, software, or programming the device 110. The housing parts 111a,111b may include connecting structures, such as for example, mounting posts, mating edges or grooves, and the like. Suitable fastening elements, such as, for example screws may be used to secure the housing components 111a,111b together. Mounting posts 111t,111u are shown in FIG. 1b, and preferably, matingly associated mounting posts are provided on the interior of the front housing part 111a. The mounting posts 111t,111u and matingly associated respective receiving sockets 111v,111w may facilitate connecting the housing parts 111a,111b together, and also may provide support for other components, such as, for example, boards and components carried thereon. Although the housing parts 111a,111b are shown in FIGS. 1a, 1b, 1c, 1d separate from the other components of the device 110, the other device components, including, for example, such as, those described herein, and shown in FIGS. 6a and 6b, may be secured within the housing 111. The components may be mounted directly to or otherwise carried within the housing parts 111a,111b, or may be mounted to another component, such as, for example, a board, which is secured to one or more of the housing parts 111a,111b.

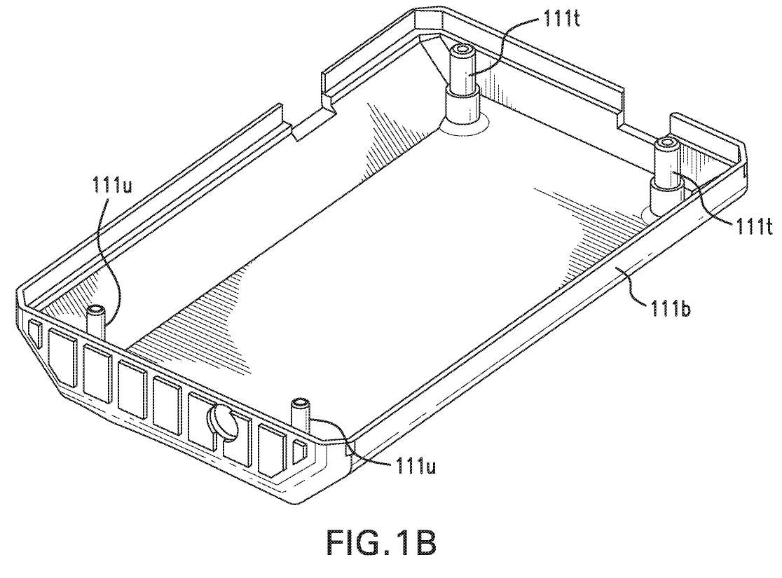

Referring to FIG. 2, a preferred first embodiment of a removably detachable accessory 112, which is the capture component 113, is illustrated having a single opening 114 therein and a single lens 115. The capture component 113 has a body 119 in which the lens opening 114 is provided. According to an alternate embodiment, as shown in FIG. 3, a capture component 213 is illustrated having a plurality of openings 214a,214b, with a plurality of lenses 215a,215b.

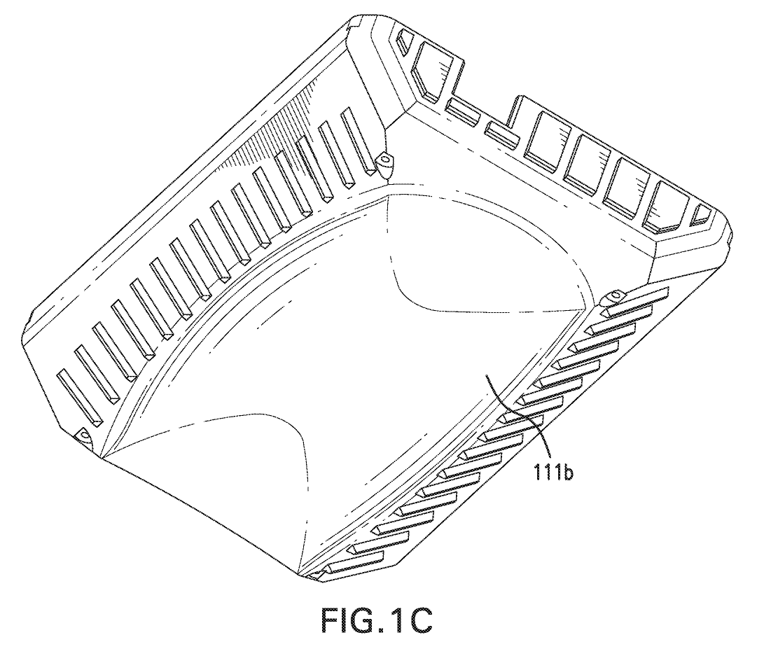

A third alternate embodiment of a capture component 313 is illustrated in FIG. 4 having a central opening 314a, a first lateral opening 314b and second lateral opening 314c, which, in the embodiment shown, are provided on each side of the central opening 314a. According to one embodiment, the capture component 313 is provided with a plurality of lenses, and according to the embodiment illustrated in FIG. 4, respectively associated lenses 315a,315b,315c, are provided for each respective opening 314a,314b,314c. The lenses may be provided to direct an image onto the sensor component or chip, which may be an image sensor or chip 316 provided on the capture component 313, or alternatively, the image sensor or chip 116 of the device housing 111. According to one embodiment, each lens 315a,315b,315c may provide an image at a particular location on the sensor chip 316, (or sensor chip 116). According to another embodiment, the images directed onto the sensor chip 116,316 from each lens 315a,315b,315c may overlap, partially or entirely. According to some embodiments, the arrangement of a plurality of lenses is utilized to generate an expanded image area capture, such as, for example, a panoramic view. The lenses preferably are arranged to capture and direct images so as to minimize potential distortion that is otherwise common to single lens viewing of a wide angle or area (e.g., a fisheye lens). According to alternate embodiments, the lenses 315a,315b,315c may be configured to capture images, and the processor may capture the images according to one method where an image from one of the lenses is continuously scanned, or alternatively, a method where the field is swapped among two or more lenses, so that images are recorded from up to three different directions. In the embodiment illustrated, up to three image planes may be captured.

According to some preferred embodiments, the capture component may include a movable mirror, the movement of which corresponds with a field of direction from one of the lenses, such as for example, the lenses 215a,215b or 315a,315b,315c, to capture images from the corresponding lens. The mirror movement may direct a field of view among one of the lenses to provide that image onto the sensor chip. The mirror may be controlled for movement using a motor or other suitable moving mechanism, such as, for example, a motor of a microelectromechanical system (MEMS).

The device 110 may be used to capture images using electromagnetic energy from one or more locations of the electromagnetic spectrum. For example, the capture component 113 may be configured to capture images based on the visible light spectrum. In addition to the visible light region, the electromagnetic spectrum encompasses radiation from gamma rays, x-rays, ultra violet, infrared, terahertz waves, microwaves, and radio waves. The type of electromagnetic radiation or energy may be differentiated based on wavelength. Embodiments of the device 110 may be configured to record images using one or more of the electromagnetic energy types.

According to an alternate embodiment, the removably detachable accessory 112 may be configured as a capture component for capturing low light images in a spectral range outside of the generally visible wavelengths. One embodiment may use infrared technology as a means for directing an image to an image sensor chip. The infrared capture system may operate using wavelengths in the range of 750 to 1400 nm, or greater. Since objects emit a certain amount of black body radiation as a function of their temperatures, the capture component 113 configured with infrared imaging elements records thermal information about the subject and the information is processed to produce an image. Preferably, a video is generated, which may be stored, transmitted, compressed or subjected to other processing as discussed herein (e.g., motion correction). The infrared capture component preferably may be configured to include infrared image sensing components, so that when the capture component 113 is placed on the device housing 111, the imaging or scenes recorded in low light conditions, using the infrared components, are processed, transmitted and stored in accordance with the device operations (e.g., streaming, heartbeat mode, privacy mode, and the like). For example, an infrared vision chip and circuitry, including a processor or microcontroller, may be provided. According to some embodiments, the device 110 includes a processor and software for processing captured images, including from an infrared capture accessory. According to a preferred embodiment, the circuitry and chip may be disposed within the removably detachable accessory 112. The device 110 or detachable accessory 112 may be configured with a vision chip that includes an integrated circuit having both image sensing circuitry and image processing circuitry. The device 110 may utilize any suitable image sensing and/or processing circuitry, such as, for example, charge-coupled devices, active pixel sensor circuits, or other light-sensing mechanism. For example, image processing circuitry may comprise analog, digital, or mixed signal (analog and digital) circuitry.

The sensor chip 116 as utilized in the device 110 (or the detachable accessory 112) records the image directed thereon, and provides an output. The output from the sensor chip is a signal, and may be a partially processed image or a high level information signal corresponding to the captured image or scene.

The device 110 preferably is configured with signal transmission components and preferably signal processing circuitry, and includes a transmitter and receiver. According to some preferred embodiments, a transceiver is provided. Referring to FIG. 6a, a schematic illustration of an exemplary embodiment of device components is shown. A transceiver 152 preferably is disposed in the device housing 111. The device 110 preferably includes one or more processing components for processing the image information or video (as well as sound information), and signals corresponding with the images and the information transmitted with the image. For example, according to some preferred embodiments, a heartbeat is transmitted at predetermined intervals, and includes a set of information, which in a preferred embodiment, provides a frame of the video, the identification of the device, the location of the device (e.g., GPS coordinates), and the time and date.

The device 110 includes a means for providing location information, and for transmitting the information along with images farm the scene (which includes video). According to a preferred embodiment, a locating component, shown comprising a GPS chip 153, is provided. The GPS chip 153 may be separately provided on the device 110, or, alternatively, may be included in conjunction with one or more of the other chips, sensors, transmitters or other processing components. The GPS chip 153 provides location information that preferably is included among the information that the processor 151 communicates to a remote location (such as a command center server) along with other information obtained with or from the device 110.

According to a preferred embodiment, the device 110 is configured with a power supply 150. The power supply 150 preferably operates the components of the device 110, including any attachments, such as, for example the capture component 113. According to one preferred embodiment, the power supply 150 comprises a battery. A preferred embodiment includes a rechargeable battery. The recharging may include circuitry with a port for supplying an external power (such as a power from an electrical power source (e.g., a power adapter connected to a wall outlet). The power supply adapter preferably is configured to match the charging requirements and current output for the device battery. Charging also may be effected using inductive power charging, by placing the device 110 with its battery 150 on an induction plate. Although the term battery is used, there may be a single battery or a configuration of multiple batteries. The batteries may further be arranged with circuitry to prolong the battery life. The battery circuitry may regulate charging and also may regulate discharge thereof, and, according to a preferred embodiment, regulates charge based on the battery capacity and composition to operate within the minimum and maximum charging capacity limits of the battery.

According to an exemplary embodiment, the power source for the device 110 may be a lithium polymer battery. Although the power supply may be internal or external, there may be options configured in the device 110 for the device 110 to be powered by an internal battery, external battery or power source, or both. The device 110 may be configured to be powered by other available power sources. For example, the device 110 may be configured to receive power from a source other than the internal battery 150, such as, for example, when the device 110 is operating in or in proximity of a mobile power source, such as for example, a vehicle. The device 110, as an alternative, may charge the battery 150 using power supplied by the vehicle, such as the vehicle's power generation or storage component (or other object configured to provide power).

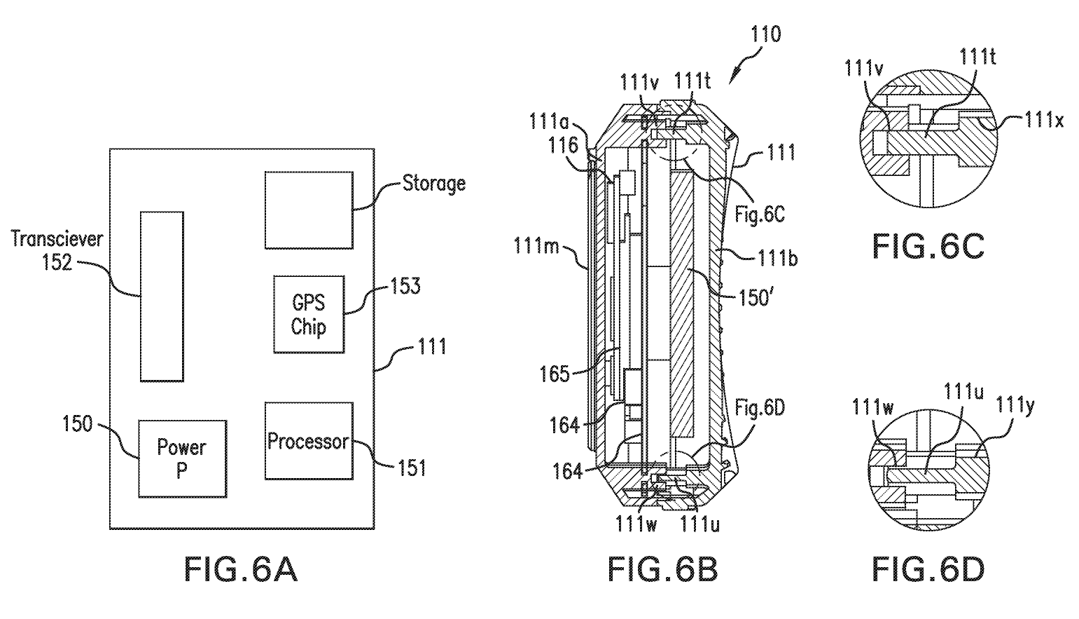

According to preferred embodiments, the device power supply 150, such as, for example, a battery, may be charged by way of wireless charging. According to a preferred embodiment, the device 110 is configured with an induction coil that is arrangeable such that when the device 110 is positioned in proximity of a separate power charger that also includes an induction coil, an energy transfer is produced to charge the battery 150 of the device 110. Referring to FIG. 7a, a schematic illustration is shown, where the device 110 is positioned proximate to a charger 162. The charger 162 includes an induction coil 161. The induction coil 161 of the charger 162 creates an alternating electromagnetic field, and when placed in proximity with the device 110 forms an electrical transformer. The induction coil 160 of the device 110, when encountering the electromagnetic field of the charger 162, takes power from that field and converts it back into electrical current to charge the battery. The device 110 may implement resonant type inductive coupling, to facilitate charging of the device when the device 110 and charger are separated from about 10 inches or even a greater distance, such as, being within a location of the same vehicle. According to one preferred embodiment, resonant inductive charging is implemented, where the device 110 is configured with inductive circuitry including a coil 160, so that when the device 110 is placed in a vehicle having a corresponding induction charger, the device 110 may receive a charge. The device charging circuitry 163, which may be controlled with software provided on the device storage, (media and/or chips, microcontroller or microprocessor) may regulate the operation of the charging.

According to a preferred embodiment, the device 110 includes battery charging circuitry 163 that maintains the charge level of the battery 150 at an appropriate level. For example, where the power source 150 comprises a lithium polymer battery, the battery level may be charged to a level that is a percentage of the full capacity for the battery (in order to prevent an irreversible or other damaging condition). The charging circuitry 163 also is configured to regulate the battery discharge upon reaching a threshold level, so that the battery will not continue to output power where it would run the risk of a total drain, which may be irreversible, or limit the ability of the battery to accept a suitable charge. For example, the battery power circuitry 163 may include software configured with instructions to determine when the battery level has reached a low threshold level of charge, and upon sensing that level, instruct the processor to discontinue use of that battery. According to an exemplary embodiment, the battery circuitry 163 includes a charge controller, which preferably regulates the charge at a predetermined voltage. For example, a lithium polymer battery may be used, having 3.7 volts as an output, where a recommended input voltage for charging the battery is regulated by the charge controller, as well as the battery's charge capacity (x percentage).

According to some preferred embodiments, the battery and charging circuitry may be configured to receive a USB input, a pin, inductive current, or other suitable means. According to some embodiments, where the device 110 includes a plurality of batteries, or where the batteries are separately operated and managed, the remaining batteries that have a suitable charge capacity may continue to power the device. According to preferred embodiments, the battery capacity is designed to provide usage between charges for a typical shift of a user, such as, for example, a law enforcement officer. According to some embodiments, the device 110 may run up to 10 to 12 hours before needing a charge. However, in the event that longer usage is required between charges, the device 110 may be configured with an additional battery (which may be internal or external), or alternatively, may be charged in a vehicle, such as a police vehicle. According to some alternate embodiments, a battery that is depleted or low on charge may be removed from the device 110 and replaced with a suitably charged battery. According to some other embodiments, the device 110 is configured so that the batteries are not readily removable or easy to remove without significant tampering or destruction of the device 110. According to some embodiments, authorized users of the device may use the device 110, but the device 110 may be constructed to permit persons other than authorized users to make repairs or internal changes to the device 110.

The removable accessory 112 preferably is configured to make one or more electrical connections with the device body 111. According to a preferred embodiment, the removable accessory 112, such as, for example, the capture component, makes electrical connections that provide power from the power supply (which may reside in the device body 111) to the capture component 113. Another electrical connection is provided between the removable accessory 112, which comprises a connection for data exchange or transmission. The capture component 113 may connect to the device body 111 and make at least one first connection that provides power and at least one second connection that provides data transmission. According to a preferred embodiment, there are two pairs of connectors, or four connection points. As shown in FIG. 1, a first pair of upper connectors 131,132 is provided, and a second pair of lower connectors 134,135 is provided. The capture accessory 112 is shown, in the exemplary embodiment, secured to the body 111 with screws which also may comprise the connectors 131,132,134,135. According to alternate embodiments, the removable accessory 112, such as the capture component 113, may be removably secured to the body 111 by an alternate securing means, which may comprise rails, locking springs, or other suitable connectors. According to alternate embodiments, mounting elements, such as rails, may be mounted to the body 111, and may be secured to the body with fasteners, such as the screws, 131,132,133,134. The rails (not shown) may include contacts that correspond with the electrical connections made by the connectors or screws 131,132,133,134. The rails preferably are matingly associated with a detachable accessory 112, so that the detachable accessory 112, which may be configured as a capture component 113, may be removably mounted on the device body 111 using the rails. According to some embodiments, the capture accessory 112 may having matingly associated mounts, such as, for example, tracks, which connect with the rails, and which include contacts that mate with the rail contacts to provide an electrical connection to the detachable accessory 112 and components therein. For example, the capture component 113 may make electrical connections with the rail contacts. As with the capture component 113 or other detachable accessories 112 which may be mounted with the fastening means, such as, screws, and removed or interchanged, a plurality of detachable capture accessories may be provided with mating tracks and may be swapped out, or customized for the usage required (e.g., night vision versus daytime), by attaching and removing a detachable accessory 112 from the rails. Capture components 113 may be provided for different uses or conditions, and be interchanged. For example, according to one embodiment, the capture component may mount to the device body 111, and connect further or additional accessories that may be used for capturing video (e.g., wired or wireless alternate camera).

The detachable accessory 112 shown configured as a capture component 113, receives power from the device power supply to operate mechanisms contained therein, such as, for example, motors, movable components (e.g., mirrors, lenses), sensors and circuitry that may be provided as part of the capture component. In the preferred embodiment illustrated in FIG. 1, at least four points of connection are shown, where two of those points are used to provide power to the capture component 113, and where two other points are used for data transmission.

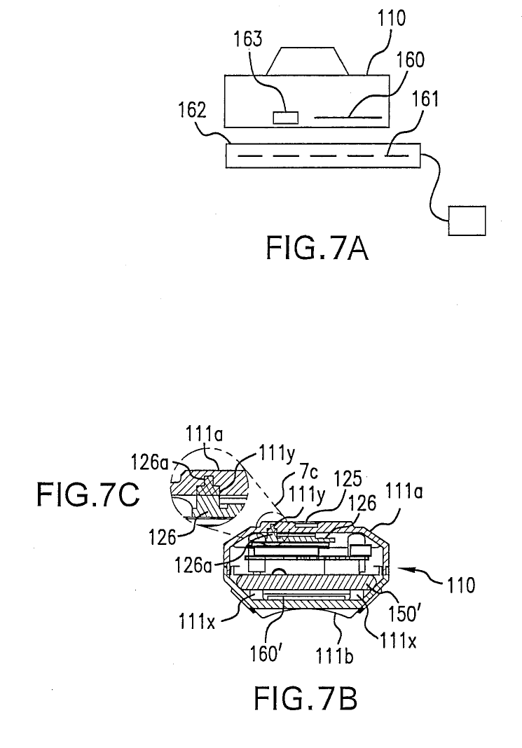

The device 110 may include a removably detachable accessory 112 which, according to some embodiments, includes a mechanism for internal manipulation of the image plane of the scene being captured. According to a preferred embodiment, as illustrated in FIGS. 8 and 8a, a capture component 413 is configured having one or more mirrors 122 that may be manipulated to alter the direction of the image plane that is recorded by the sensor chip 416. The alteration of the image plane directs the image from a particular viewpoint for capture by the device 110. As shown in FIG. 8, the image plane (PL1) represents a first image plane, while image plane (PL2) represents a second image plane. Referring to FIG. 8a, the mirror 122 is provided on a movable mount 123, which may be a movable axis, and is regulatable between a first position where the mirror 122 directs the image capture from a first direction, and a second position where the mirror directs the image capture from a second direction. According to a preferred embodiment, the mirror 122 is provided in a first position to provide the image from plane (PL1). Upon rotation of the mirror 122, from the first position to an alternate position, a different plane may be imaged. For example, in the exemplary embodiment illustrated, the mirror 122 may be moved to a second position to provide the image from the second plane (PL2). Preferably, the mirror 122 is configured with an associated moving or drive mechanism 124, which may include one or more driving means, such as, a motor, that may directly drive the mirror 122 to move the mirror 122 between positions. The mirror mount 123 may be provided with or in conjunction with the drive mechanism 124. According to some embodiments, the mirror 122 may be indirectly driven with one or more other components that the motor may move, such as, for example, a pinion and gear arrangement, turret, and the like. The mirror position may be controlled remotely, through a command center or remote server that is configured to access the device 110. For example, where the device 110 is worn on the body of a user and is looking directly forward (for example toward PL1), and there is activity occurring above, in order to capture the active event, the mirror 122 may be shifted by the moving or drive mechanism. Alternatively, a user may place the device 110 in a variety of positions on the body, chest, shoulder arm, and the like. The mirror moving mechanism 123 facilitates capturing of scene from an image plane that may be relevant to the user given the device 110 orientation.

According to some preferred embodiments, the device 110 is configured with one or more sensors that may be configured to regulate the operation of the mirror 122, so that, based on the orientation of the device 110 as worn by the user, the mirror 122 is placed into a position to capture the image plane that is directly in front of the user. Sensors of the device 110, such as, for example, the IMU and other sensors, such as, for example, gyros, accelerometers, may provide information to the processor 151 (see, e.g., FIGS. 6a, 6b)(or other microprocessor or controller) to adjust the mirror 122 to a capture position. For example, the processor 151 may regulate the operation of the mirror moving or driving mechanism 154. The mirror 122, once initially adjusted, may be provided to remain in that position for a predetermined time period, or until a repositioning event occurs (unit is powered down, a command is received from the system remote center, or other trigger). Although, the processor 151 is shown in FIG. 6a, alternatively, a processor, microprocessor or microcontroller may be provided in conjunction with or as part of the mirror driving mechanism 154.

As shown in FIG. 6b, the device 110 is illustrated in accordance with an exemplary configuration. A battery 150′ is shown removably mounted within the housing 111. The device housing 111 preferably is configured to secure the battery 150′ in the device 110 when the housing parts 111a,111b are brought together for engagement. The housing front part 111a and rear part 111b are shown with the mounting posts 111t,111u, which matingly fit within the respectively associated sockets 111v,111w. According to some embodiments, screws (not shown) may be used to secure the posts 111t,111u to the sockets 111v,111w (e.g., by installing them through the housing part 111b, see FIG. 1c). As shown in FIGS. 6c and 6d, the mounting posts 111t,111u include shoulders 111x,111y. The shoulders 111x,111y preferably are configured to engage a component, such as, for example, a board of the device 110, and may provide support for one or more components. Processing and transmission components are provided, and are shown in the exemplary embodiment, including a Sierra Wireless® board 164 (such as for example an AirPrime® board) is provided as part of the device circuitry. In addition, in the embodiment illustrated, an Atmel® board 165 with circuitry for processing communication transmissions. For example, the Sierra Wireless® board may provide a first component for communication (such as for certain networks, Qualcomm®, Verizon®, LTE, whereas, the Atmel® board may provide communication for alternative networks, (e.g., Wi-Fi and other cellular networks). Further components, such as, for example, an image sensor 116 is provided for capturing images, and, according to some preferred embodiments, the device 110 may include a video card for processing video from the information received from the image sensor. The components, such as, for example, video processing cards or chips, image sensors, and communications components, may be separately provided or one or more of them may be integrated. The device 110 preferably includes at least one processor for processing information from the device components, including data from detection sensors, such as, for example, sensors associated with actuation functions of the device 110, such as, switching of modes and processing instructions for device operations and communications. According to some embodiments, the housing 111 may include one or more openings through which inputs, such as, for example, sounds, lights, vapors, and the like, may pass and be monitored by sensing components, such as the device sensors. The housing 111 is shown, in an exemplary embodiment, having openings 111z provided therein for receiving inputs upon which the sensors may act. For example, sound, vapors, light, and other elements may pass through the openings 111z. Device openings 111z, or other openings (not shown) may be provided to allow access to internal speakers or microphones. The housing parts 111a,111b are configured to secure the battery 150′, the cards 164,165, and other components of the device 110 (e.g., video cards, processors) in a secure condition. According to preferred embodiments, the housing parts 111a,111b are configured with edges and dimensions to engage the device components to retain them in position within the housing 111.

The actuation button 125 is shown in FIGS. 7b and 7c with a switch 126. A switch interface is shown, and the housing front 111a has a matingly configured bore 111y for receiving an end 126a of the switch 126 therein.

As illustrated in FIG. 7b, the device 110 shown with an optional wireless charging feature that preferably comprises an induction coil 160′, which is provided in conjunction with the battery charging circuitry. The induction coil 160′ may function similar to the induction coil 160 shown and described herein (see FIG. 7a).

The device 110 includes one or more sensors that are configured to regulate operations of the device 110. The sensors preferably include force and movement detection sensors that detect impacts, shocks, jolts and other activities that disturb the device 110. For example, when a user wears the device 110 on the user's body, certain movements may give rise to an event signal that corresponds with the sensed condition (e.g., such as the user running). When a user wearing the device 110 is running, a device sensor, such as, for example, an impact or motion sensor, issues a signal that may be processed and identified as meeting or exceeding a condition, such as, for example, a threshold level. According to a preferred embodiment, the device 110 may be used in a first mode of operation, where the device 110 begins sending a heartbeat to a remote component, such as, for example, a server at a command center. The first mode may be a low level information mode, where the device 110 obtains and/or transmits information (including, for example, image frames or video, location, sensor data, such as speed, conditions of user and user environment) at a reduced rate. According to some embodiments, the first mode may be referred to as the heartbeat mode, and the heartbeat may comprise a transmission sent by the device 110 of the user identification (user ID), the date and time, the GPS location, and a single video frame, which preferably is an HD quality or higher video frame. The mode may be set to send this information at every predetermined time interval. For example, the heartbeat mode may send the transmission every second, or, alternatively, may send the heartbeat at another designated interval, e.g., every second, or every 5 or 10 seconds, every minute, or other suitable span. For example, a user of the device 110 may be a first responder or emergency personnel, such as, for example, a police officer. Since a police officer must respond immediately to activities taking place, the device 110 is configured to operate in a higher information rate state, where the device 110 increases the information captured (e.g., the frequency or amount of information) and/or the transmission of the information. According to some embodiments, the higher information state, for example, may be a second mode, which streams the information, including captured video of a scene, from the device 110. The second mode may be actuated by the user or actuated automatically when a triggering event or condition takes place. The triggering event or condition, for example, may be an action taken by the officer, such as, for example, commencement of running. The device 110 also includes sensors that are configured to detect external stimuli, such as, for example, changes in light (e.g., a muzzle flash, flashing lights, a flashlight). For example, where an officer turns on the flashing lights of an emergency vehicle (e.g., a police vehicle), one or more sensors of the device 110 are configured to detect the lights. According to a preferred embodiment, the sensors may be configured to capture light-related information through one or more openings in a capture accessory 112, which may include capturing the light through a lens 115 of a capture component 113. Alternatively, sensors may be provided elsewhere in the device body or housing 111, or included within a capture accessory 112. The detection of the flashing lights is one condition that when occurs and is sensed by the device 110, switches the device 110 from the first mode (e.g., heartbeat mode) to a second mode. When the device 110 is placed in the higher rate state, such as the second mode of operation, the device 110 streams video captured from the device capture component 113. The device 110 preferably also is configured with one or more sensors that react to loud sounds and impacts, such as, for example, a gunshot. Preferably software includes instructions for monitoring the signals from the sensors, and preferably the sensor signals are processed to determine whether the signal corresponds to a triggering event or condition. A library of sounds may be provided and stored on the storage means of the device 110. The library may include sound profiles to which the sensor signal may be matched in order to determine whether a threshold or trigger has been reached. Alternatively, the activation may be triggered by a threshold decibel level being reached. The library according to some embodiments may have a library of signals or patterns that do not trigger the condition, such as, for example, the sound of a car door lock.

Sensors of the device 110 may be provided to sense conditions of the user, such as, for example, body temperature, respiration, heart rate, and other functions, as well as environmental conditions, such as sounds (e.g., gun shot, glass breaking, vehicle horn, crash, helicopter, particular words or the manner of speech), light, vapors, alcohol, smoke, hazardous gasses, atmospheric gasses, pressure (e.g., barometric), water, humidity, shock, magnetic fields, motion (e.g., acceleration, impacts, position, orientation, velocity).

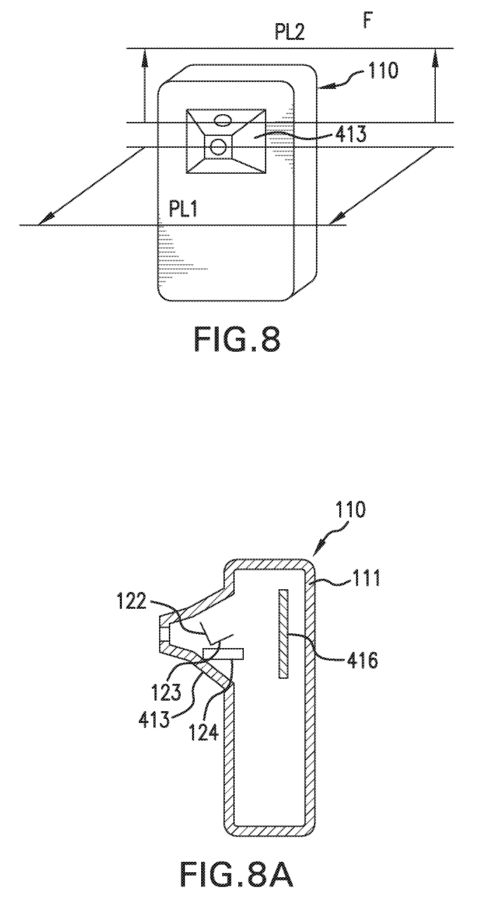

In addition to sensor actuation, such as, for example, light and sound detection, the device 110 preferably may be configured to increase the information and/or transmission rate, for example, placing the device 110 into a second mode of operation by a remote command being sent to the device 110. For example, a command center 700 (FIG. 9) to which the device 110 transmits information may desire to receive streaming video from the device 110, and may send a command or signal to actuate the device 110 to operate in a second mode, and stream video. Similarly, the device 110 may be configured to accept further commands from a remote command unit, such as a server 701 (FIG. 9), one of which, for example, may be to return the device 110 to the first mode, or heartbeat mode.

The device 110 also may be used in another mode of operation, referred to as a third mode of operation, which is a privacy mode. The privacy mode is configured to interrupt the device transmission, and, according to some embodiments, also interrupts any recording of video (and sound) by the capture component. For example, where a user takes a restroom break, the user may place the device 110 in the third mode, which is a privacy mode. This may be done by triggering an actuator on the device 110, such as, for example, depressing an actuation button 125. For example, to place the device 110 in privacy mode, the actuation button 125 may be depressed and held until an audible tone is sounded. In addition, one or more LED indicators also may be provided on the device to correspond with the device privacy mode, or other modes (e.g., first mode and second mode). The device 110 may be configured to allow privacy mode to be implemented for only a predetermined time interval, such as, for example, three minutes, or any other desirable time, after which, the device 110 returns to one of the other modes, such as, for example the first mode or heartbeat mode. For example, the device 110 also may be triggered from privacy mode to operate in the second mode or streaming mode, upon the detection of a sensed event or condition. For example, in the case of a loud noise that is a triggering event (due to the sound pattern, decibel level or other actuating condition), a device 110 operating in the first mode or in the privacy mode is switched to the second mode to transmit streaming video (and audio, as well as location, and identification information). The device 110 may be automatically returned to the second or streaming mode when a further triggering condition (a return event or condition) is sensed. For example, where the device 110 is operating in the first or heartbeat mode, or in privacy mode, and a device sensor senses a condition that indicates an impact (e.g., from a fall) or rapid acceleration, the device 110 preferably is placed into the second or streaming mode, and, according to a preferred embodiment, live video stream is transmitted to a remote location (such as a command server 701), as well as recorded onto storage and backup storage of the device 110.

The device 110 is shown in accordance with a preferred embodiment including a transmitter and receiver, or transceiver 152. The device 110 also may have one or more antennae (which preferably may be internal) for communicating and receiving signals. According to preferred embodiments, the device 110 is configured to operate on a plurality of networks. For example, the device 110 may operate using wireless mobile networks 707 (FIG. 9), such as, those provided by cellular/wireless network carriers (e.g., Verizon®, AT&T® and others), as well as through Wi-Fi, WiMAX (see e.g., 708, FIG. 9), microwave or other communication bands.

The device 110 preferably operates in conjunction with a remote component or system. According to an exemplary embodiment, the command server 701 may communicate with the device 110, and control one or more functions of the device 110. For example, the command server 701 may operate the lens of the capture component 113, and zoom the lens in and out, or it may actuate the camera, or microphone to send recorded images and sound. For example, the lens 115 or other lens, such as those shown and described herein, may be configured as a zoom lens, with one or more microelectromechanical elements to move the lens components to change the focal length. The command server 701 preferably is configured with software that includes instructions for instructing the processor to deliver commands to the device 110 to implement device operations and components of the device 110, including for example, the capture accessory 112. The command server 701 preferably may view information from a plurality of devices 110, and may control a plurality of devices 110. For example, where a number of users of the devices 110 are converging in the same location, the command server 701 may provide options for selectively controlling the devices 110. Devices 110 may be in the second mode with each device 110 attempting to send live video transmission through what may be the same network. In order to select the preferred view among the several views that the respective devices 110 are providing, the command server 701 may be operated to regulate which device 110 (or devices 110) stream to view, and may turn of the transmission from one or more, or all of other devices 110. Preferably, the command server 701 is configured to send a command to a device 110 that instructs the device 110 transmission to cease. Although the device 110, not transmitting, may continue to record video, sound and capture images from the scene, the bandwidth is now expanded for the transmitting device or devices 110 to use. The implementation of transmission facilitation may be achieved through the device regulation. The command center server 701 also may be operated to regulate which device 110 is transmitting, based on the view desired. For example, a rooftop view may be desired, and the server 701 may select the device 110 being operated on the rooftop to transmit.

The device 110 preferably is configured to capture information that may be used as evidence. The time and date stamp preferably may be provided on the frame as part of or along with the recorded image capture. The device 110 preferably is compatible with evidence and mapping systems, including geographical information systems (GIS), such as, for example, evidence and/or mapping systems commercially available from L3, ArcGIS, MobilSolv, and Google Earth.

The device 110 also may be configured to autonomously upload data from the device 110 or any of its storage components. The upload may be remotely configurable, such as, for example, from a remote command server through a network. Alternatively, uploads from the device 110 may be condition or event driven. For example, where the device 110 is charging and has access to a suitable network connection, the device 110 may be configured to provide an update by uploading captured information stored on the device 110 to a remote computing unit that is accessible through the network connection (such as a command server 701). According to some embodiments, the upload may be further regulated to be operable when the device 110 or server 701 to which it is uploading determines that the network provides a suitable connection (in terms of speed, reliability, bandwidth, other connection or transmission qualities, or combinations thereof). Alternatively, the device 110 may have an actuation mechanism for actuating an upload feature that uploads stored information, including captured images frames, video, location information, user identification, sensor functions, and other information that the device 110 is configured to sense and store. The actuation mechanism may comprise a button, or button sequence of the button 125. The device 110 also may have a port through which a connection may be made, e.g., with a cable, to connect the device 110 to a network. Alternate embodiments are configured with an autonomous upload actuation system (AUS), which is configured to transmit an upload of stored information from the device 110 to a remote component, such as a server 701, at a predetermined status or time interval, such as, for example, during charging or when a communication connection meets a certain transmission or bandwidth requirement.

The processing circuitry of the device 110 preferably includes software configured with instructions to instruct the processor to implement transmission of a stream from the device 110 of the video of the scene being observed with the capture component 113. One or more storage components, such as flash storage, programmable memory chips, or other suitable storage means, are provided for storing the instructions. Preferred embodiments of the device include a processor. The processor may be provided as a separate processor, a microprocessor or as a microcontroller integrating stored instructions, memory and processing capability. In addition, one or more sensors may be provided to operate in conjunction with the processor, or may be configured as part of a sensor provided microcontroller or microprocessor.

According to preferred embodiments, the device 110 includes a smoothing component for enhancing the captured video. The device 110 preferably includes one or more sensing components for sensing movement, such as, inertia. For example, the device 110 may be configured with an inertial sensor or inertial measurement unit (IMU). The inertial measurement unit measures the acceleration and angular velocity along three mutually perpendicular axes. The IMU preferably measures the acceleration and velocity of the device 110 or its components, such as, for example, the lens 115 of the capture component 113. The inertial measurement unit senses motion and provides an indication, preferably through a signal. The device includes software configured with instructions for monitoring or receiving an indication from the IMU. The IMU may sense movement, for example, where the device is on a person who is running. The device 110 preferably includes a capture component 113, which includes one or more smoothing components. The capture component 113 preferably includes or is associated with an IMU. The IMU preferably may contain components, including, for example, accelerometers and gyros. According to one preferred embodiment, the capture component 113 has electrical and/or electronic, and more preferably microelectronic elements, to carry out responsive actions to compensate for image stability when the device 110 is in motion. According to a preferred embodiment, the capture component 113 is configured with MST/MEMS elements. For example, the devices may be fabricated on silicon using conventional silicon processing techniques. Alternatively, other materials that may be used include SOI, SiC, diamond microstructures and films, smart cut type substrates (SiC, II-VI and III-V, piezo and pyro and ferro), shape memory alloys, magnetostrictive thin films, giant magneto-resistive thin film, II-VI and III-V thin films, highly thermo-sensitive materials. In some embodiments, the IMU comprises MST/MEMS. According to a preferred embodiment, the capture component 113 includes high rpm motors, preferably, microelectronic motors, which move one or more elements of the capture component 113 in response to the IMU sensing signal. According to one preferred embodiment, the motors are associated with the image input element, such as, a lens 115, and may be operated to move the lens 115 along a path to stabilize the lens 115 as against inertial conditions acting on the device 110. Preferably, the microelectronic stabilizing motors remain in a static condition, and are actuated when a stabilizing event occurs. According to one preferred embodiment, a gimbal is provided to maintain the level of the lens of the capture component, and more preferably, 3-axis gimbals are used. One preferred embodiment reduces the vibrations that are imparted on the device 110 by providing a configuration of a motors, and more preferably, high rpm motors, such as brushless motors. One exemplary embodiment is configured with three brushless motors. When the device undergoes movement, and the capture component 113 is recording an image, the image would otherwise be recorded where the lens 115 of the capture component 113 points. The stabilization component, including gimbals, preferably, facilitate maintaining the capture component, and more preferably, the lens 115, level on all axes as the device 110 is moved. The inertial measurement unit (IMU) is configured to respond to movement of the device 110, and preferably, includes or is associated with one or more motors, such as, for example, the three separate motors, to stabilize the image by regulating the position of the capture component 113, such as an image capture element or lens 115. Preferably, the stabilization component is configured with an algorithm that detects motion based on the motion detection components and determines whether the stabilization feature is to be actuated. For example, motion association is programmed in the algorithm to associate particular types of motion with action or inaction in regard to the stabilization mechanism of the smoothing component. One exemplary embodiment is configured with instructions to receive motion data, and, upon sensing motion data corresponding with that of a walking motion, does not result in the stabilization actuation. In the exemplary embodiment, the device 110 is configured so that when the user of the device 110 engages in motion that is more aggressive, than walking, and the motion data sensed has changed, the stabilization mechanism of the smoothing component is actuated upon the motion data reaching a correspondence with a threshold, pattern or other predetermined data event. The actuation of the stabilization mechanism receives information from the IMU (and other sensors that may be operating in association therewith) and operates one or more motors in a corresponding manner to reposition the image capturing element, such as the lens 115 of the capture component 113. According to a preferred embodiment, the image capturing element, or lens 115, may be rotated about three axes, for example, with three gimbals, such that roll, pitch and yaw are compensated for when the device 110 is undergoing movement of a type that calls for the stabilization.

According to one embodiment, the IMU may be provided having three orthogonally mounted gyros which sense rotation about all axes in three-dimensional space. The gyro outputs drive one or more motors controlling the orientation of the three gimbals as required to maintain the orientation of the IMU.

A stabilization algorithm preferably is configured to regulate differences between movements of the device 110, for some conditions where the stabilization is not being called for, and for other conditions where the stabilization is desired to benefit the recorded image being captured. The stabilization mechanism may be configured with software containing instructions to instruct the processor to process the information sensed by the IMU, and in conjunction with other sensors, to carry out a procedure to adjust the coordinates of the image location on the image sensor 116. The adjustment preferably is made by moving the image in relation to the sensed movement of the device 110. According to preferred embodiments, the algorithm provides the adjustment parameters, which, according to a preferred embodiment, are based on sensor responses, including information provided by the IMU, and other sensors that may be part of or associated therewith (accelerometers, gyros, and the like). The image movement may be translational based on adjustment parameter coordinates.

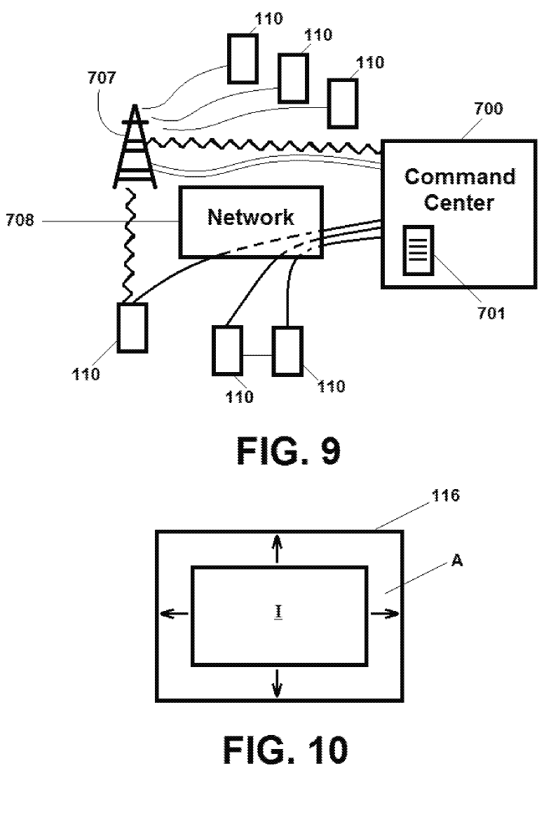

According to some preferred embodiments, the IMU provides information that identifies the exact position of the image capture element. The IMU data preferably is processed according to an algorithm to assign which rows and columns of the image sensor are to be the image capture area. As illustrated schematically in FIG. 10, preferably, a video chip, such as the image sensor chip 116, is provided and includes an area “A” of rows and columns. Preferably, pixels make up the rows and columns. The image area “I” preferably is a subset of the chip sensor area “A”. In this manner, the image area “I” may be designated by coordinates to be within the area “A”, but since the image area “I” is smaller than the total sensor area “A”, the image area “I” may be captured at multiple locations on the chip sensor area “A”. For example, if the image area “I” has a baseline condition that is central to the image sensor area “A”, then the image area has the ability to be moved in two directions horizontally, and in two directions vertically. The image sensor 116 preferably comprises a chip that provides for resolution that is greater than the resolution of the image area “I”. For example, according to one embodiment, the image area “I” is HD, and the sensor chip 116 is an ultra-high definition (UHD) chip, where a suitable portion of the image, which is HD resolution, is used for the image area “I”. The image sensor 116 on which the sensor area “A” is provided is an ultra-high definition (UHD) sensor. According to alternate embodiments, the image sensor 116 may be configured having resolution that is greater than HD, such as xHD, where x is a factor corresponding to the image area “I” and sensor area “A”. For example, the image sensor may be 1.5 HD, and the image area “I” full HD, for an image of x units and a sensor area of 1.5×units. Alternate embodiments include utilization of image sensors having high resolution, including HD, UHD and 4K UHD image sensors. The image sensors preferably are chips that capture the image directed thereon through a capture element, such as, for example, a lens 115 of the device 110.

According to preferred embodiments, the capture component 113 includes the image capture element (such as a lens 115), and optionally may include a sensor chip 116′ (see FIG. 5). According to preferred embodiments, the capture component 113 is removably detachable from the body 111 of the device 110, and may be changed out with an alternate capture component (see e.g., 213,313,413). For example, a capture component may be provided with an HD sensor, or sensor to provide HD imaging. Alternatively, an alternate capture component may have a 4K UHD sensor chip. The capture components may be replaced to provide a desired feature set (e.g., HD, UHD, 4K HD). According to some embodiments, the image sensor chip 116 may be located in the body 111 of the device 110. According to some alternate embodiments, the image sensor chip may be located in the capture component (see 116′ and 113′ of FIG. 5). Where the image sensor chip 116 is located in the device body 111, one alternative is to provide a replaceable capture component 113′ (FIG. 5) that is supplied with its own sensor chip 116′. For example, where the device body 111 includes an HD chip and higher resolution is desired, a capture component may be supplied with an UHD chip. The connections made by the UHD alternate capture component reroute the image capture sensor circuitry to use the capture component image sensor. Preferably, this is done by removing the existing capture component 113 and installing the alternate capture component, such as the component 113′, on the body 111. Similarly, capture components, such as, for example, those 113,113′, may be supplied separately from the device body 111, so that customization of the device 110 and its uses may be designated by the user.

According to an alternate embodiment, the device 110 may be supplied with a high resolution sensor chip, such as, for example, an UHD chip, but may be configured to provide lower resolution. According to this alternate embodiment, where a device user or owner requires higher definition imagery, the device 110 may be upgraded to utilize the UHD capability. The upgrade feature may be a software update, such as, for example, a key that may be provided or purchased for activation of the feature.

The device 110 preferably records and streams video. Preferred embodiments of the device 110 are configured to use compression features to compress the video images captured using the device 110. According to preferred embodiments, the device 110 is provided with a video compression or coding algorithm to facilitate the throughput of the video captured with the device 110. Preferably, the compression or coding algorithm compresses the video image to minimize the amount of data that is transmitted. Some benefits that may be achieved using the compression algorithm include the benefit of improving the speed at which the image may be transferred, e.g., from the device 110 to the command server 701 (FIG. 9), as well as reduction of bandwidth required to transmit it. According to some preferred embodiments, the coding format may be any suitable format, such as, for example, H.264, H.265 or MPEG-4. According to some preferred embodiments, the device 110 includes software configured with instructions to process the image information from the sensor chip 116 and compress the image information prior to transmission thereof The instructions preferably include a compression algorithm. Any suitable compatible compression algorithm may be used for the video compression.

According to some embodiments, the compression of the video captured using the device may be designated in accordance with formats and compression standards, and may be compatible with one or more profiles that may be used by the device 110, and by a server 701 receiving information from the device. For example, in accordance with the H.264 format, baseline, main and high (and other) profiles may be implemented, where, P-slices (predicted based on preceding slices) may be supported in all profiles, and where B-slices (predicted based on both preceding and following slices) are supported in the main and high profiles, but not in a baseline profile.

The video image data may be represented as a series of still image frames. The compression algorithm is configured to evaluate the frame sequences, which may include one or more past frames, and, in some embodiments, may also include one or more subsequent frames, for spatial and temporal redundancy. According to some alternate embodiments, interframe compression may be implemented, which uses one or more earlier or later frames in a sequence to compress the current frame. Other alternate embodiments may utilize intraframe compression, uses only the current frame information for compression. The redundancy may be eliminated, since it does not change in those considered frames, and the code required to transmit those redundant or eliminated portions is therefore not needed. The image transmission may be smaller in size and therefore require less bandwidth for its transmission from the device 110 to the remote component, such as the server 701. The processor may be instructed in accordance with the algorithm to encode the captured image or video by only storing differences between frames. According to some embodiments, the compression algorithm may be instructed to average a color across similar areas, in order to reduce the size of the information that is required to be stored or transmitted. The device 110 may be provided with options for users to select one or more levels of compression, or may automate the compression level based on the quality or speed of the communication network.

According to one preferred embodiment, the compression algorithm compares information between subsequent video image frames. The instructions provided on one or more memory storage components of the device 110 process the image to provide the algorithm the vectors of the image. The algorithm includes instructions to process the image information, and the processor is instructed to process the image information and preferably compares the vectors, and further processes the information by moving the vectors. According to preferred embodiments, the algorithm is configured to use motion prediction, and according to further preferred embodiments, the algorithm is configured to apply motion prediction and motion compensation to the captured image. The data transmission containing the captured video image may be encoded with a suitable coding algorithm, transmitted, and decoded when received at the receiving component (such as, for example, a server 701 to which the video image from the device 110 is sent).

According to a preferred embodiment, the device 110 is configured with a compression algorithm to compress the video image captured with the capture component 113. The video compression algorithm preferably includes instructions to reduce redundancy in the video data. According to a preferred embodiment, the device compression algorithm is configured to provide spatial image compression of the captured image and temporal motion compensation of the captured image. According to some embodiments, the video compression is carried out using a block arrangement, where the algorithm takes into account information from square-shaped groups of neighboring pixels, or macroblocks. The software containing the algorithm preferably is provided on the device 110 (or device component) and includes instructions to instruct the processor to compare the pixel groups or blocks of pixels from a successive frame or frames. For example, pixel groups or blocks are compared from one frame to the next. The algorithm includes instructions to communicate only the differences within those blocks. For example, where there is more motion taking place in portions of the video image, the compression algorithm is configured to code more data because a greater number of the pixels are changing.

According to preferred embodiments, the compression algorithm preferably includes a prediction algorithm, which may include prediction vector instructions for processing image information from a captured image. The prediction of the video image in a frame of the video is carried out by a reference to another frame of the video. For example, the reference frame may be a previous frame (or in some cases may be a future frame), and the comparison of a considered frame to a reference frame may be carried out to determine the points of difference, such as, a change in movement between the frame under consideration and the reference frame. This permits compression to improve and reduces the amount of data that is to be transmitted, particularly where there are portions of the frame that correspond with the reference frame (such as the frame portions that remain unchanged). According to a preferred embodiment, a video stream is transmitted and the frames are transmitted. Preferably, the frames are transmitted so that there is at least one reference frame (which may include the information for all pixels in the reference frame or an algorithm for its generation, for example, where some pixels are known and others are generated). The frames are transmitted so that less of the image pixels need to be part of the transmission. The algorithm that encodes the video image captured by the device capture component 113 is also associated with an algorithm at the receiving location, such as a server 701 that receives the transmission of the video image. The information, e.g., data received, includes frames of the video image. The server 701 is provided with software containing instructions that include a decoding algorithm for decoding the data transmission containing the video image stream. The transmission may include portions of an image frame, and the algorithm known to the server 701 may be implemented using a processor of a computing component, such as, for example, that of the server 701 to which the image stream is sent, to decode and assemble the frames in the sequence and with the pixel information to produce the captured video image. As discussed herein, according to preferred embodiments, information transmitted from the device 110 to a remote component, such as, for example, the server 701, is protected through encryption, such as, an encryption algorithm.

According to preferred embodiments, the image transmitted from the device 110 is streaming video which is communicated in real time as the event is occurring, as the device 110 captures the event.

According to preferred embodiments video captured with the capture component 113 is stored on local media, which preferably is carried on the device 110. The local media image storage preferably is done both, when the image capture is not streaming on a network (that is, when it is not transmitting to a remote source) and when the image capture is streaming to a remote location or component. The device 110 may be configured to accept removable storage media on which information may be recorded, including device identification, device operations (modes, times, dates, sensed events, event information, images, and other information that the device and its sensors receives and/or detects). The removable storage media, according to one embodiment, is a slot with contacts for a flash memory element, such as, for example, an SD card. The device 110 also is configured with a backup component for backup storage of information, including captured video. The backup component preferably may include embedded or permanent storage, such as a flash memory or solid state drive, which receives the captured video as well as other data. The backup storage may receive the same information that the device is configured to write to the removable storage media. According to some preferred embodiments, the captured video may be stored on the backup storage in the same manner as the transmitted video, with the video compression applied pursuant to an algorithm.

According to a preferred embodiment, the data is encrypted, and multiple levels of encryption may be provided. For example, one first level of encryption is the storage of information to the backup or hard storage of the device. The information stored on the hard storage preferably is encrypted, so that in the event that the device 110 were to be lost or stolen, the contents of the captured image and other information are not readily accessible, without a decryption key, code, algorithm or other security element. Similarly, the transmission of the captured image data and information sent from the device 110, including, for example, from the sensors, is encrypted to provide another measure of security. Another level of encryption is provided in connection with communications from a remote command to the device 110. The encryption of transmissions for commanding certain controls of the device 110 is done to prevent unauthorized tampering with the device 110 through attacks. Any suitable encryption method or algorithm may be used in connection with the device and transmission of data therefrom.

According to some preferred embodiments, the algorithm is provided with the image pixel information, from blocks or pixel groups. The device 110 preferably is configured with an IMU which may operate in conjunction with one or more other sensing components, such as, for example, accelerometers and gyros. Preferably, information from positioning sensing components, such as, an IMU, is utilized by the compression algorithm. The positioning sensing component, such as, for example, the IMU, utilizes the position data to determine whether the device 110 is in motion, and is configured to relay that information for processing. According to a preferred embodiment, the stabilization component of the device 110 includes software configured with instructions that compensate the image movement based on the positioning sensing components, such as the IMU information. For example, the IMU may detect movement, and issue a signal that when processed results in in instruction to shift the pixels in response to the sensed device movement. The stabilization component preferably includes a stabilization algorithm that transforms the image data in response to the data provided by the IMU or other positioning sensing components. According to preferred embodiments, the lens may remain fixed in place, while the positioning sensing components, such as, for example, the IMU, provide information that, instead of moving the lens, moves the image. Preferably the image movement is moved relative to the image position, or proximate thereof, that the lens, if moved in accordance with the position sensing components or IMU would have directed the image in relation to the sensor chip. When device movement is sensed as a condition, the pixel shift may be inverse to that of the device motion detected by the IMU. The compression algorithm considers the blocks of the image captured on the image sensor 116. The motion vector for each block, or block group that is being evaluated by the algorithm are processed by determining whether the block is the same. The motion vectors are considered to provide information about the captured image. The captured image may be processed by the compression algorithm to provide the changes to the frames of images being processed. According to a preferred embodiment, the device 110 includes image movement information from the position sensing components, such as the IMU, and image change information from the compression algorithm. This information provides a first location vector and a second location vector. The IMU sensor information (or other position sensing component information) may be processed to provide a determination of where the image requires to be adjusted, and preferably does so by providing an instruction to move the image vectors. The image vectors preferably comprise pixels or blocks, or groups of pixels or blocks. According to preferred embodiments, the algorithm determines whether to move or change an image vector. According to a preferred embodiment, a compression algorithm is configured to produce a compression motion vector. For example, the IMU is configured to provide an IMU motion vector. According to a preferred embodiment, the image is transformed according to a transformation implementation that provides compression of the video and stabilizes the video to smooth imagery where the device 110 was moving during the capture. The device 110 may include software configured with instructions to further implement adjustment of the image by subtracting the IMU motion vector from the compression motion vector. The expression MV_{C}−MV_{IMU}=AMV, may be used to provide a preferred image adjustment where MV_{C} is the motion vector for the compression algorithm, where MV_{IMU} is the motion vector corresponding to the IMU motion vector, and where AMV is the adjusted motion vector. According to preferred embodiments, the AMV represents a compressed or encoded video image that is also stabilized for undesirable movement. The device 110 may transmit captured image data, which may be a video stream, which is received as a stabilized frame or stabilized video stream where streaming video is transmitted. Although described in connection with the IMU, alternatively, or additionally, one or more position sensing components may provide information used to carry out the image adjustment.

According to embodiments of the invention, the adjustment may be made in conjunction with the small frames (FS). For example, the portion of the sensor area SF′ or FF from which the image is taken to comprise the video frame, which is represented by FS, or FS1, or FS2 . . . , may be used to provide an adjusted motion vector (AMV). In this example, a motion vector may correspond to the IMU motion vector, and that vector may be used to adjust the small frame SF image location on the larger frame area (SF′ or FF) of the sensor 116. The expression MV_{C}−MV_{IMU}=AMV, may be used to provide a preferred image adjustment where MV_{C} is the motion vector for the compression algorithm, where MV_{IMU} is the motion vector corresponding to the IMU motion vector, and where AMV is the adjusted motion vector.

According to preferred embodiments, the compression algorithm also includes instructions for compression of the audio, which, preferably, is done in parallel with the video compression. According to preferred embodiments, the compressed video and compressed audio may be sent together, combined, even though they may be processed as separate data streams.

Embodiments of the device 110 preferably may be configured to include a macro video stabilization mechanism for stabilizing the apparent video that is captured using the device 110. The device 110 may be used by an individual who is in motion (e.g., running, or on a motorcycle) or may be used in association with a moving structure or other element in motion. In those instances, the running motion of the individual (or movement of the structure) may displace the device 110 position relative to the scene being captured, so that the device 110 physically captures the scene image from different positions. The device 110 is configured to determine when there is motion activity affecting the device 110, and, the device 110, upon sensing the motion activity, actuates the macro video stabilization feature to implement motion correction of the apparent video of the scene. The device 110 preferably is configured with one or more sensors, such as, for example, sensors that detect the device motion and position. According to one embodiment, position and motion sensing components, which preferably may comprise one or more sensors, are configured to monitor conditions of the device 110, and to provide electronic signals in response to the conditions sensed. The device 110 preferably includes a processing component, such as, for example, a processor, microprocessor or microcontroller. The device 110 also includes software which may be stored on a storage component of the device, or be provided as part of a microcontroller or other device circuitry. The software provides instructions for processing the electronic signals from the sensors, and comparing a signal to determine whether a condition, such as, a threshold, has been met. For example, the threshold may be a minimum movement change, pattern of movements, or other activity, and may be evaluated within a particular period of time, interval. For example, sensing of movement corresponding with substantially vertical up and down displacements, may correspond with running and a need to implement the stabilization feature. The macro video stabilization feature reduces the appearance of movement when the video of the scene is viewed. Embodiments of the device 110 are configured to “macro-stabilize” the apparent video that is captured by the device 110. According to some preferred embodiments, video captured with the device 110 preferably is stored, recorded, and transmitted as stabilized video.

The stabilization feature is designed to allow the capture of a scene where the device movement is the result of purposeful movement of a user, such as, for example, a turn in direction, while stabilizing the video frame with regard to movements where the camera motion is incidental to the activity, such as when the user is running. According to a preferred embodiment, the stabilization mechanism includes one or more position sensing components. For example, the position sensing components may include sensors that detect movements of the device 110 and/or orientations of the device 110. According to some preferred embodiments, the position sensing components may comprise one or more of inertial measurement units (IMU's), accelerometers, gyros, and other elements suitable for detecting positions and movement. The stabilization mechanism preferably includes one or more processing components, such as a processor, microprocessor or microcontroller. The stabilization mechanism preferably includes software with instructions for instructing the processing component to monitor data from the sensor or sensors, and process the data. The software is stored on storage media, such as, for example, memory or chips, and may be provided as part of chips associated with a sensor or other circuitry of the device. The processing component is instructed to detect and compare the sensor data to determine the level of movement. For example, according to a preferred embodiment, the sensors may provide data indicating a level 1 or first level movement. The first level movement preferably is identified as movement that relates to such actions, like shaking, which is not the user's purposeful activity. For example, a user wearing the device 110 may decide to run. While running is a purposeful activity engaging in by the user, the shaking is a consequence of the engaged in activity, i.e., running, and the position of the device 110 being on the user's body. The device 110 and attached capture component 113 shake as a result of the user activity, e.g., running. The image capture of the scene video, as recorded with a shaking device 110 and capture component 113, would continually change the direction of the image capture. The device 110 and capture component 113 would be moving with the body of the user and would receive the abrupt motions due to the user running Each movement changes the direction from which the device 110 and attached capture component 113 records the scene. The image stabilization mechanism compensates for first level type device movement. The first level type device movement is sensed by the sensors, and the processor, upon identifying from the sensor data device movement that is first level movement, processes the movement as motion vectors.

According to some embodiments, the stabilization component algorithm may be implemented to actuate the stabilization mechanism. The stabilization component may provide motion association that identifies first level type device motion. The stabilization component may actuate an alternately configured stabilization mechanism which provides frame-field stabilization. Motion sensor data, such as, for example inputs from position and motions detecting components, may be correlated with the positioning of a frame on a sensor field, to select a frame whose location on the sensor field is adjusted to compensate for the motion.

The first level movement preferably is determined by the sensor data meeting a threshold, which may, for example, be a number of movement changes in a particular time interval, or movement directions changes in a particular time interval. The motion vectors preferably are in an x,y coordinate plane and represent a reduced image area of the sensor 116. The processor is instructed to evaluate the movement information provided by the sensors, and compare the information with thresholds that correspond with movement and time components, and, preferably both. The movement and time information may provide indications of first level device movement.

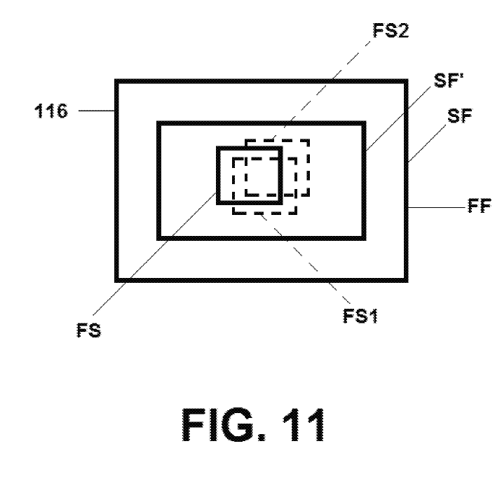

Referring to FIG. 11, according to one embodiment, the image is represented by a frame FF on the sensor field SF (such as, for example, the image area A, in FIG. 10). The frame FF may, in a designated imaging mode, such as, for example, an initial capture mode, be all or a majority (see, e.g., SF′) of the sensor field SF. According to some embodiments, the stabilization mechanism preferably includes software configured with instructions to select, preferably, on a frame-by-frame, basis, a smaller frame of video FS out of a larger sensor frame (e.g., SF) to eliminate the effect of movement of the wearer which is due to user activity such as running (or other motion affecting the device 110). The processing of the sensor data that identifies first level movement is carried out and the frame selection is rapidly responsive to the sensor data and its processing. For example, the shaking movement of the device 110 may be sensed as first level movement, and smaller frames FS1, FS2, FS3 . . . FSn, may be captured from portions of the sensor field SF area (e.g., portions of the SF′ or the full frame FF area).

The device 110 may be configured to autonomously implement the frame-field stabilization mode (FFSM) upon one or more position sensors detecting a response, and the processor, identifying the sensor data with a threshold or other target. For example, a device 110 may record in a full-frame capture mode, where the image is recorded on the entire frame (FF) or larger portion SF′ of the sensor frame SF. The full-frame capture mode (which in some embodiments may involve capture on larger frame, though not the entire sensor area) may comprise an imaging mode. The device 110 may be configured to operate in the full-frame imaging mode (FFIM). The full-frame imaging mode (FFIM) may be an initial mode and may be configured to be a standard or default imaging mode. The device 110 may be configured to return to the full-frame imaging mode (FFIM) after the device 110 has operated in the frame-field stabilization mode (FFSM). The device 110 may be returned to the full-frame imaging mode (FFIM) after a certain time period, or, when user motion, or preferably, user motion that is not first level motion, is no longer being detected. The imaging modes may be operated with any device transmission mode of operation, such as, for example, the periodic or frame mode, or second or streaming mode. According to some preferred embodiments, the device 110 is configured to operate in an imaging mode that is the full-frame imaging mode (FFIM), and, upon a triggering event, e.g., commencement of running by the user, and detection of that event by the one or more sensors that detect position and movement, the device 110 operation changes to a frame-field stabilization mode (FFSM).

The stabilization mechanism also may detect movements that do not meet a first level movement threshold or parameter. These detected movements may be designated second level movement. Alternatively, the sensors may be selected, or controlled with associated program instruction, to provide responses at threshold levels, so incidental movements do not change the imaging mode. For example, second level movement may be where a user is turning a corner. Instead of compensating for the movement, the sensor data preferably provides information that the device 110 is being moved in a continuous direction. The continued motion of the turn, for example, does not meet the threshold parameter for first level movement, and the device 110 does not compensate for the movement of the device 110 along the turn. The processor preferably is instructed to compare the movement direction and change over time (which may be a short time interval). In the case of more deliberate movements by the user, such as, turning a corner, or rising up from a seated position, the movement is sensed over a longer time duration (compared with when the device 110 is experiencing rapid changes in direction or velocity or acceleration). For example, the movement data generated by a device 110 carried on a user who is walking and changing direction to turn a corner shows continued motion in the similar direction. The first level movement, on the other hand, preferably recognizes abrupt changes, which are changes of motion (e.g., speed, acceleration, direction) within short time durations. Alternatively, or in addition, the implementation of stabilization features may be configured to involve the detection of patterns of movements, including continued movements or abrupt movements. The movement patterns may be stored for comparison, and when a device movement is identified, such as, by processing sensor data and timing, device movement corresponding with a pattern may determine whether the device 110 implements a stabilization feature, such as, for example an imaging or stabilizing mode (e.g., FFIM, FSIM).

According to some preferred embodiments, the stabilization mechanism may stabilize motion of the device 110 with regard to the capturing of a scene, where the device 110 is undergoing first level type movement and second level type movement. The determination of the first level movement may actuate the frame-field stabilization mode (FFSM) to capture and record frames FS from the image sensor area field SF. The location of the imaging frames FS are adjusted based on the first level movement, and, preferably, the second level movement does not change the frame location. According to some preferred embodiments, the device 110 is configured to process movements and time. For example, where first level and second level movements commence together, the movement types may be discerned. Software preferably is provided on the device storage media, and contains instructions for instructing the processor to record and store sensor data and time (in temporary or other memory), and further for processing the data to carry out a comparison of the movement and time data to determine whether the movement qualifies as first level movement. The processor is instructed to conduct a temporal comparison, which may involve, movement sampling from the position sensor data. The movements sensed may be assigned position direction vectors, and the image sensor smaller frame FS may be selected from the sensor frame SF (or SF′) based on the sensed movement. The sensed movements may correspond with time, so that the small frames FS may be selected corresponding with the time motion.

According to some embodiments, the image sensor 116 may be fixedly mounted on the device 110, such as, for example the device body 111, or alternatively, on a capture component 113. According to some embodiments, the image sensor may be fixedly mounted to the capture component 113.

According to some alternate embodiments, the image sensor of the device body 111 or a capture component 113 may be associated with moving components. For example, the image sensor 116 may be moved by a sensor moving mechanism to compensate for the first level movement. The sensor movement may take place, and may be in motion during the time when the movement is detected and determined to be first level movement. For example, movements that are changed direction, velocity, orientation, vibration, within a short duration of time, may be detected and assigned first level movement.

According to some alternate embodiments, the stabilization mechanism preferably is configured to move the image sensor relative to the lens 115 of the capture accessory 112. According to one embodiment, the image chip or sensor 116 is provided in the device body 111. The image sensor 116 may be mounted for movement, preferably, in a configuration where the sensor 116 may be moved horizontally and vertically, and preferably within a plane. The translated movement of the sensor 116 repositions the image area “I” of the sensor 116 (an example of an image area “I” being illustrated in FIG. 10) so that the capture of a video frame is made at a particular location of the sensor 116. According to some preferred embodiments, the image sensor 116 is movable in vertical and horizontal directions, such as, for example, over an x,y coordinate plane. According to some preferred embodiments, the stabilization mode of the device 110, when implemented, optically has the image sensor 116 enter a mode where each frame of the video is selected from a larger sensor frame, such as, for example, an HD frame (e.g., the image area “I” represented in FIG. 10) out of a UHD size sensor (e.g., the sensor area “A” represented in FIG. 10), such that there are two time constants associated with the stabilization mode. One time constant is rapidly responsive and selects frame-by-frame a smaller frame of video out of a larger sensor frame to eliminate the movement of the wearer which is due to the activity such as running, while a longer time constant in the algorithm allows for general changes in the direction of the apparent intended field of view, such as, for example, when the wearer is making a turn in direction on purpose. The stabilization feature is configured to capture a scene using frames of video, where the device movement is the result of purposeful movement of a user, such as, for example, a turn in direction, while stabilizing the video frame with regard to movements where the camera motion is incidental to the activity, such as when the user is running The implementation of the sensor movement, according to embodiments where the sensor is configured for movement, may be carried out as described herein in connection with embodiments of the invention, where the sensor may be moved to adjust and control the positioning of the frame location on the sensor field.

The device 110 preferably is configured to regulate the rates of information and transmission. Device operation modes may implement regulation of information, such as, video capture rate, frequency of sensor data (i.e., readings), as well as transmission rate. The information and transmission regulation may be automatically determined based on the device location.

The device 110 preferably includes a locating feature, which may include one or more location-determining elements. For example, GPS location coordinates may be obtained with a location determining element, such as, for example, a GPS chip, like the GPS chip 153 shown schematically in FIG. 6a. The device location may be continuously recorded, stored, and processed. The device location also may be transmitted to a remote location (such as a command server) as part of the device data (e.g., information, video, sound, conditions, and the like). Preferably, the location is a GPS coordinate location.

The device 110 may be programmed by providing specified location boundary parameters. The boundary parameters may be one or more locations. According to a preferred embodiment, the boundary parameters comprise one or more GPS coordinates. For example, a single GPS location coordinate may be used to designate a boundary. The boundary may be specified as a radius from the location, a square about that location, including that location or using that location as a reference point. According to some embodiments, the designated boundary area includes GPS coordinates defining a boundary, which may be a geometric shape, or any shape. Examples of boundaries may be a route, a building, a jurisdiction, an area of real estate, schoolyard, or other location that is of interest. The device 110 preferably may be manipulated, such as with programming, updates, settings and features, by connecting the device 110, in any suitable mariner, to a computer, e.g., through a cable through a device port, or wirelessly. The computer may be a local computer, or, according to some embodiments, may be a remote computer, such as a command server. The term server, as used herein, may be any computer, including a desktop, or computer having a server configuration. Location boundary designations may be provided and stored on the device 110, for example, in a storage component of the device 110 for access by the processing functions of the device 110.

The device location boundary parameters may be associated with one or more device operations, including device sensors, image capturing, transmission, and other functions of the device 110. The information obtained and transmitted from the device 110 may be coordinated with the boundary parameter settings. The location of the device 110 may be determined by a locating component, such as, for example, the GPS chip 160. Alternatively, or in addition thereto, the device locations may be determined through proximity to signal generating or receiving elements (such as, for example, cell towers, network access points, and the like), or satellites. The locating component, such as, for example, a GPS chip provides GPS coordinates that indicate the location of the device. These coordinates may be stored, and form part of the device information that is communicated to the server 700.

The device 110 is configured to regulate the rates of recording of captured images as well as transmission of information. According to preferred embodiments, the device 110 is configured to determine the device location, and process the location to determine whether a location condition is met. A location condition, for example, may be the device 110 location, such as, for example, the device 110 being within or outside of a designated location boundary. Where the processed location information meets a location condition, then the device 110 may implement one or more operations, which may be changes to operations of the device 110. The device software and processing components of the device obtain the location coordinates, and compare the location coordinates to the stored boundary locations. When the current boundary location meets a stored boundary, then the device operation or condition is implemented. The implementation of a device operation may include setting a particular capture rate, which may include changing of the current rate to a capture rate to increase the information that the device 110 obtains (e.g., more image frames in a time interval), or less information (less image frames in a time interval). Other information may be regulated based on the device location, such as, for example, sampling rates (e.g., rates at which the sensor information is recorded). For example, where the device 110 includes a sensor for detection of radiation, upon the device being located within a designated area, the device 110 may implement monitoring and recording of sensor information (e.g., radiation level) at an increased time frequency (e.g., a reading per second, instead of per minute or per five minutes, or no reading at all). In this example, the device sensor is configured to detect radiation, and the device 110 enters a location that is predetermined to be of interest for radiation content. The device 110 automatically commences (if it is not already doing so), or increases, radiation sampling. Similarly, one or more device operations, or rates may be implemented based on a reading of the sensor (e.g., when radiation is sensed), regardless of the location, providing multiple triggers for obtaining the information when the device 110 is in the field.

The device 110 also may regulate the transmission rate based on the device location. For example, the rate at which information is transmitted from the device 110 (such as, for example, captured images, sensor data, location information), may change based on the location of the device 110. According to some embodiments, the device 110 is configured to regulate the rates of transmission of information (as well as the rate of recording of captured images). The device 110 processes the location information and determines whether the device location is a designated location, such as, for example, within a location boundary or outside of a location boundary. The boundaries preferably are designated GPS location boundaries. The device 110 preferably may include instructions for designating a transmission rate based on the location. The device 110 may be programmed to actuate operation of a particular transmission rate and/or information rate in association with one or more particular locations. The device 110 transmission rate may involve changing the transmission rate from the current transmission rate (including where there is no transmission currently being made), to an increased transmission rate (e.g., transmitting a stream of information rapidly, e.g., continuously or at a high rate), or a decreased transmission rate, transmitting information or a frame in a longer period (e.g., once per minute). The capture rate and transmission rate may be independently configured, or may be configured to be correlated. For example, the device 110 may be in a location where both the capture rate and transmission rate are increased. The device 110 may be in a location where the location determination transmission rate is not increased, but rather, the capture rate is (e.g., where the captured video of the scene is stored to the device 110, but where transmission remains the same or even decreases. One example, is where a law enforcement officer enters into a zone where the location parameters correlate with an interest in having more information, but where a number of officers are at the location and are transmitting through the same network. In order to regulate speed and bandwidth capability and availability, the command center (see e.g., 700 in FIG. 9) may implement transmission rates of certain devices 110 to be low or off, while other devices 110 may be transmitting. However, the device 110 may, by being in a boundary of interest, record image captures at a high information rate. Similar to the information rate discussed herein, multiple triggers may be provided to regulate the transmission rate, such as, for example, a device operation, a reading of a sensor (e.g., when radiation is sensed) regardless of the location, thereby implementing regulation of the transmission rate based on location and/or a condition. The location of the device is determined by a locating component, such as, for example, a GPS chip. Alternatively, or in addition thereto, the device locations may be determined through proximity to signal generating or receiving elements (such as, for example, cell towers, network access points, and the like), or satellites. The locating component, such as for example, a GPS chip, provides GPS coordinates that indicate the location of the device 110. These coordinates may be stored, and form part of the device information that is communicated to the server, such as the server 700.

According to preferred embodiments, the device 100 may be configured to trigger a mode of operation when the device 100 is in a particular location. The triggering location may be a designated location that is defined by GPS location coordinates of the device location matching a designated location at or within which it is desired to have particular device operations actuated (e.g., increasing the recording rate, transmission rate, or both). For example, one trigger can be when the GPS coordinates are within a certain distance of a target list of GPS coordinates, or within the bounding shape of a set of coordinates. Where the device 1110 is inside the bounding shape, including a bounding circle or box or other shape artificially generated by the specification of one or more points and an associated shape, one example being a central point and a radius, and other examples including a central point and a square (i.e. square blocks), or, another example is a simple list of points which are assumed connected, the device records video, and/or the heartbeat information rate increases (i.e. from once per minute to once per second), or other device feature is actuated. For example, where a law enforcement or a military person using the device 110 is on an operation (such as, for example, a drug bust, or counterinsurgency operation) then the device video commences recording automatically on approach.

Another example of the device boundary is where the device user enters a particular area where others have an interest. For example, a command center operation or personnel may have an interest in an area in which a law enforcement officer enters. The designated location may or may not be known to the officer. The interest may be conditions or events within in a desired location boundary, and the device 110 may operate to provide greater information, such as the rate of the information, sending, and video (e.g., the image rate (video) increase), when the device 110 is within the location boundary. The device 110 may commence recording at the higher rate, and transmission of video may commence, if it is not already being transmitted. For example, the increased information rate may include increasing the capture rate from a single frame every 2 minutes, or a frame every 10 seconds, or to full motion 30 fps video. The device video rate increase and transmission occurs based on the device 110 being in the designated location area or zone.

Conversely, the device 110 may be configured to engage in one or more modes of operation when the device 110 is outside of a particular defined boundary. The device 110 location, when within a boundary, may operate according to one or more operation modes, and when the device 110 is outside of a boundary, one or more other modes of operation may be implemented. For example, the device 110 leaving a designated boundary or zone may trigger an operation so that the video and/or more detailed recording of parameters occurs only when the device 110 goes outside of the bounding area. The device 110 may be used for safeguarding children. For example, a child may wear the device 110 on the child's neck or on a backpack. The device 110 is configured with a capture component 113 that records scenes. When the child is walking home from school with the device 110, so long as the child is on the proper route, which is a route programmed as a boundary, then the device 110 transmits a heartbeat (e.g., a reduced information rate, e.g., a frame every minute). However, when the child strays outside the prescribed path, the location boundary is breached, and the device 110 processes the location information and identifies the lack of correspondence with the route boundary. The determination of the route boundary breach actuates an operation mode of the device 110 to provide increased information. For example, the increased mode preferably, implements recording of video (e.g., a frame per second, or higher rate, even 30 fps video), and the transmission, which prior to the boundary breach may have been sending a frame every minute, may transmit increased information, such as continuously transmitting the information, including the video, sound, location and other information that the device 110 has obtained through its sensors and components.

The device 110, system and method may be configured to have increasingly, progressive triggers, so as to escalate the recording and transmission of information and video as events occur. For example, the device 110, system and method may be configured with a multiple-layered trigger. Information may be obtained by the device 110, including, information obtained from device sensors, the device capture component 113, locating chips, and other device components. The device 110 may be configured to provide information pursuant to an information rate. For example, increasing the information rate may increase the amount of information obtained by the device sensors and cameras, and may increase the amount of information transmitted from the device 110.

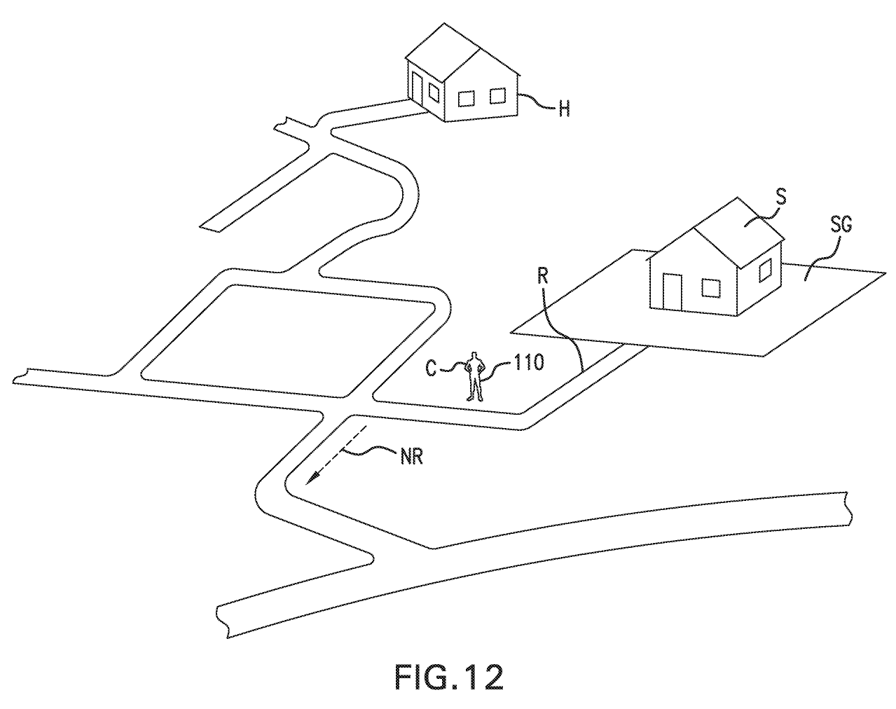

For example, referring to FIG. 12, there is illustrated a schematic diagram of a device 110 within a boundary. The boundary represents a route R that a child C takes when walking home from school, S. The school grounds SG also may be a boundary, and, the school S, school grounds SG, may be considered as a single boundary, or separate boundary. The route R may be stored as a separate boundary also, but may be configured to be considered together with the school S and grounds SG. The device 110 may be provided on the backpack or other article, or worn by the child (e.g., on the child's neck or clothing). In this example, the child C is walking from school S to home H. A route NR is shown to represent a boundary that is outside of, and not within the usual path for the child C to take. Upon leaving the rout R, the device 110 location component, such as the GPS chip, provides the location coordinates, and the location coordinates are processed to determine an out of boundary or boundary breach condition. The software instructs the processor to implement operations of the device 110, which in this example, is to increase the capture rate (to more frames per time period, e.g., to full video) and to increase the transmission rate. The device 110 may continue the increased information and transmission rate modes so long as the child C is out of the designated route R. According to some embodiments, the device transmission may be to a remote component, such as, for example, a server. The server may carry out functions, such as alerting, based on the route divergence condition.

The device 110 is configured to regulate the amount of information that the device 110 obtains, records and/or transmits The rate of information may be increased or decreased, and the increase or decrease in information may be in regard to any one or more component of the device 110. The amount or frequency of information from one or more sensors may be regulated, by increasing it, or decreasing it. Information captured and recorded may be regulated. The rate of capture may be increased or decreased. The capture rate information may involve adjustment of the frequency of image captures or frames (in the case of images and video), to increase the number of frames captured in a period, or decrease the number of frames captures in a time period. The information from the sensors also may be regulated. For example, the information rate may be increased to provide sensor signals or readings of a greater frequency, so there are more data points for sensed conditions within a period of time. Conversely, the sensor data may be decreased so there are less data points within the time interval or within a greater time interval. The transmission rate also may be regulated based on the device location.

The device 110 preferably may be operated or manipulated to control the rate of any information recorded (with the capture component, device component, such as the sensors), or transmitted by the device 110.

The device 110 is shown according to a preferred embodiment, with a detachable accessory 112 that is configured as a capture component 113 capable of recording images, including video. According to an alternate embodiment, a device is provided comprising a mobile sensor apparatus. The device includes a housing, similar to the housing 111 shown and described herein. The device may be configured with the circuitry shown and described herein in connection with the device 110, including, for example, in FIGS. 6a, 6b, 7a and 7b, which provides processing and transmitting capabilities. The mobile sensor apparatus preferably may include one or more sensors, as shown and described herein in connection with the device 110. The detachable accessory may be provided as shown and described in connection with the accessory 112. The detachable accessory may be configured to sense a condition, such as, for example, an environmental agent (e.g., chemical or gas) or property (e.g., radiation). The mobile sensor apparatus may be configured with software containing instructions for carrying out location determinations. The mobile sensor apparatus also may regulate operations, as discussed in connection with the device 110 and location regulation. The mobile sensor apparatus may operate by determining the location and comparing the location with locations parameters. The capturing of information from one or more sensors and/or transmission of information from the apparatus may be regulated based on the apparatus location. A detachable component 112 may be provided for removable detachment to and from the apparatus, in particular the housing, such as the hosing 111 of the device 110. The alternate embodiment mobile sensor apparatus may include a detachable accessory with one or more sensors provided therein. The apparatus may be configured to communicate with a remote server through a network.

The following are proposed examples of utilization of the device, system and methods, and are not intended to be limiting.

### EXAMPLE 1

A device 110 is provided and worn by a user on the user's body. An optional harness may be provided, or alternatively, the device 110 may be directly attached to the user's garment (which may be directly attached or attached via a mounting component). The user is a law enforcement officer who, upon commencing a shift, obtains a device 110. The device 110 may be removed from a charger or charging station which may be at the station or other facility. The device 110 preferably is logged on to in order to identify the user. The logon to the device 110 may be accomplished by the user using an identification, such as, a user password, biometric or other security mechanism. Alternatively, the devices 110 may be distributed to a user at the commencement of a shift. In some embodiments, the user may maintain the device 110, and charge the device 110 as needed. The law enforcement officer user wears the device 110, and the capture component 113 is directed forward to record images in front of the officer. The device 110 commences in a first operating mode which is a period mode, where images are captured and recorded every second. In the period mode, the image and information, such as, the identification of the officer or device 110 identification number, the location, are transmitted to a command center server which it remote from the officer. The command center server preferably communicates with the officer device 110 through one or more networks. For example, where the officer is within the station and the device 110 is initially actuated for use within the Wi-Fi network of the station, the device 110 may communicate through a network, using the Wi-Fi connection. When the officer leaves the signal area of the Wi-Fi network, the device 110 may transmit the information to the command center using another network, such as, for example, an available cellular network. The device 110 may be worn as the officer is driving in a vehicle. In this example, the officer is on a patrol and in a squad car. The device checks for movement, based on the data provided by the sensors, and the device operates in an initial capture mode which is a full-frame imaging mode (FFIM). The officer is called to an accident scene, and the officer uses the squad car siren and flashing lights. Upon the siren sound, the flashing lights or both, one or more of the device sensors senses the event, and a trigger is detected. The device 110 is placed into a second mode, which is a live streaming mode, and, where previously a frame per second was sent to the command center, upon implementation of the second mode, live streaming video of the scene is transmitted to the command center. The officer turns off the siren, and leaves the lights flashing. The device 110 continues the second mode operation. The officer upon arriving at the scene notices an individual on the ground, and runs toward that person. The commencement of running by the officer actuates the device frame-field stabilization mode (FFSM), and the video captured and streamed to the command center is motion stabilized. The officer prepares a report, and takes witness statements. Once the scene is cleared, the officer returns to the squad car, the device 110 may be switched to first mode by the officer. Alternatively, the device 110 may be switched to the first mode by the automatic operation of the device 110, such as, where the officer returns to the vehicle and turns off the flashing lights, or where the officer drives away from the scene at a pace of speed that is not determined to be excessive or emergent. In this example, video is encrypted prior to being transmitted.

### EXAMPLE 2

Similar to Example 1, video captured by the device where the motion stabilized video is processed with a compression algorithm and frames are adjusted using the motion adjustment vector and a compression vector.

### EXAMPLE 3

Similar to Example 1, but the officer's condition is monitored, so that respiration and heart rate are part of the information communicated to the command center.

### EXAMPLE 4

Similar to Example 1, but the officer at the accident scene is using a device with multiple camera directions, and, an operator viewing the streaming video at the command center implements control of the device capture component 113 to change the direction of the scene being captured in order to look at the view of the accident.

### EXAMPLE 5

An insurance adjuster is on location inspecting a real property building. The adjuster uses the device 110 and turns on the recording mode to record the portions of the property, e.g., rooms, fixtures, mechanical and plumbing systems, are recorded as the adjuster moves through the property. The adjuster makes spoken notes as the adjuster moves through the property and the sound is recorded with the video. The adjuster encounters a major condition or violation that would negate the inspection outcome. The adjuster switches the mode to the live streaming mode. The adjuster depresses a button on the device 110 to change the mode from capture and recording to device 110, to an alternate mode, such as a second mode, where, in addition to record and capture to the device, the live streaming video is transmitted.

### EXAMPLE 6

An individual is taking transportation to a care facility to receive medical treatment. The transportation is a van which picks up the individual at the individual's home or other location, and transports the individual to a care facility for an appointment. The device 110 is worn by the individual, and transmits in a first mode, video and information, to a family member of the individual. The family member may access the scene frames and other information by logging on to a remote server, or logging on to the device 110 through a communication component that communicates with the device. In this Example, the remote server is a center for following ones family member through the transportation to the appointment and the return trip. The family member can observe the individual, the locations where the individual is and has been, and can plan accordingly, for when the individual is returning (e.g., to greet them or assist them).

### EXAMPLE 7

A child is provided with the device 110 which is mounted on the backpack of the child. The device 110 travels with the child to and from school. The information from the device 110, including location, identification are sent to the remote server. The remote server receives the information, and stores the information. The information includes a frame of video per time period (e.g., one frame per second). The device also records and stores the information and video. The remote server is configured to permit access to one or more authorized users, which in this Example, are family members, a mom and dad, sibling and grandparent. In this Example, the child is taking the bus to school, and arrives. The child stays late at school and is not on the bus home. The parent logs in to access the remote server and is able to determine the child is still at school.

### EXAMPLE 8

This is similar to Example 7, above, except that the family member may have access to the video and information, and device operation (e.g., changing modes from periodic to live streaming) The parent sees periodic frames when logged on to the remote server, and the parent manipulates the device 110 through the server to switch from periodic mode to live streaming mode. The parent is able to see the child is with a teacher and others at school.

Although video is referred to in the description, video and live video preferably includes audio as well. These and other advantages may be realized with the present invention. For example, motors may be associated with one or more capture component elements, so as to move the one or more elements relative to the lens. One example is where the image sensor is carried on a movable element, and the image sensor is movable when the carrier element is moved. The device is shown with a removable accessory 112, which according to preferred embodiments is configured as a capture component 113,213,313. Alternative accessories may be provided for connection with the device body 111, such as, for example, when the removable accessory is configured to connect with another component (e.g., such as a sensor or camera on a helmet). In addition, the device 110 may include a speaker and a microphone, and may be configured to recognize voice commands from the device user. The position sensing components may sense the position of the device 110 and movement of the device 110. Sensors discussed herein may be provided as part of or with a circuit board, and may be furnished with a processor. According to some embodiments, the sensors may be provided on a circuit board of the device, and according to alternate embodiments, the sensors may be provided on one or more separate boards. For example, the IMU may be provided with processing circuitry that contains storage components with software for instructions for processing the data provided by the IMU. The IMU may include a multi-axis gyroscope. In addition, although referred to as a first mode of operation, and second mode of operation, the information and/or transmission rates may be implemented throughout a range, from zero information rate, to low information rates up to higher information rates. The transmission rates also may be implemented throughout a range from no transmission, low transmission rates, up to high transmission rates. The devices 110 may be configured to regulate the rates based on conditions of the user, environmental conditions, or as controlled by a command center (or in some cases, the user, e.g., actuating/deactivating a privacy mode). While the invention has been described with reference to specific embodiments, the description is illustrative and is not to be construed as limiting the scope of the invention. Various modifications and changes may occur to those skilled in the art without departing from the spirit and scope of the invention described herein and as defined by the appended claims.

What is claimed is:

1. A portable field image recording device comprising:
a) a housing;
b) a communications component for receiving and transmitting data, said communications component disposed within said housing;
c) a removable capture component carried on said housing and being removably detachable therefrom;
d) a rechargeable power supply disposed in said housing;
e) wherein the removable capture component is configured to make an electrical connection with said housing;
f) wherein the removable capture component electrical connection comprises at least one power connection and at least one data transmission connection;
g) wherein the removable capture component includes a lens.

2. The device of claim 1, including:
at least one sensor for sensing a condition of an environment;
a processing component configured with instructions for monitoring information from said at least one sensor;
wherein said device is configured with a controllable rate of obtaining information, and wherein said device is configured with a controllable rate of transmitting information;
wherein said device is configured with software containing instructions to instruct the processing component to monitor responses from said at least one sensor, wherein said rate of obtaining information comprises the rate at which said device monitors responses from said at least one sensor.

3. The device of claim 2, wherein said rate of transmission is regulated based on responses from said at least one sensor.

4. The device of claim 2, wherein said capture component includes a movable mirror for capturing images from a designated position, wherein said capture component has at least two openings, each said opening defining a direction from which images may be captured, said movable mirror being positionable in relation to said openings to select the direction of image capture.

5. The device of claim 1, wherein said rechargeable power supply is charged by inductive charging.

6. The device of claim 1, wherein said capture component comprises a plurality of lenses, and where each lens is directed to capture an image from a different point;
wherein said plurality of lenses comprises at least three lenses, including a first lens for capturing from a first point, a second lens for capturing from a second point, and a third lens for capturing from a third point;
wherein said first lens is disposed to capture from a relatively first linear direction, and wherein said second lens is disposed to capture from a direction relatively angular to one side of said first capture direction, and wherein said third lens is disposed to capture from a direction relatively angular to another side of said first capture direction; and
wherein said lenses are arranged to capture a panoramic field of view.

7. The device of claim 1, including a second removable capture component, wherein at least one of said first capture component and said second capture component captures images in visible light, and wherein at least the other of said first capture component and said second capture component captures images in low light conditions.

8. The device of claim 7, wherein the other of said first capture component and said second capture component that captures images in low light conditions comprises an infrared capture component.

9. The device of claim 2, wherein said device includes software configured with instructions for instructing the processing component to process information from said capture component and transmit said information through a network to a computing component.

10. The device of claim 2, wherein said rate of obtaining information further comprises the amount of captured video frames within a time period.

11. The device of claim 10, wherein said capture of video is controllable within a range from recording one frame every five minutes, to 30 frames per second.

12. The device of claim 1, including a location component, said location component being configured to provide location information, wherein said location information provides a location of the device, wherein said device is configured with a controllable rate of obtaining information, wherein said device is configured with a controllable rate of transmitting information; and wherein said device controllable rate of obtaining information and said device controllable rate of transmitting information are regulated based on said location information.

13. The device of claim 2, including at least one location component, said location component being configured to provide location information, wherein said location information provides a location of the device, and wherein said device rate of obtaining information and said device rate of transmitting information are regulated based on said location information.

14. The device of claim 13, wherein said device operations of obtaining information and transmitting information are regulated by said device location provided by said device location component, and by said at least one sensor for sensing a condition.

15. The device of claim 14, wherein said condition is one or more of sound, motion, vibration, pressure, light, vapors, alcohol, smoke, hazardous gasses, atmospheric gasses, water, humidity, shock, magnetic fields, radiation, acceleration, impacts, position, orientation, velocity, body temperature, respiration, heart rate.

16. The device of claim 15, including:
an image stabilizer;
at least one image sensor having a sensor field, said sensor field having an area;
wherein said at least one sensor for sensing a condition comprises at least one position sensor for detecting movement of the device;
wherein said image stabilizer comprises a frame selection mechanism for selecting a frame on said sensor field which is smaller than the area of said sensor field; wherein the location of said selected smaller frame is located on said sensor field at an adjusted location which is adjusted based on the movement of the device to compensate for the movement of the device.

17. The device of claim 16, including a storage element, wherein said image stabilizer includes software configured with instructions to instruct the processing component to process data from said at least one position sensor to determine whether said movement is a triggering movement, and where said processed position sensor data corresponds with triggering movement, to adjust, on the sensor field, the location of the smaller frame forming the image, said device being configured to record video to said device storage component, said recoded video comprising a plurality of smaller frames captured at their respective adjusted locations.

18. A portable field image recording device comprising:
a) a housing;
b) communications component for receiving and transmitting data, said communications component disposed within said housing;
c) removable capture component;
d) a rechargeable power supply disposed in said housing;
e) wherein the removable capture component is configured to make an electrical connection with said housing;
f) wherein said removable capture component electrical connection comprises at least one power connection and at least one data transmission connection;
g) wherein said removable capture component includes a lens;
h) at least one sensor for sensing a condition of an environment;
i) a processing component configured with instructions for monitoring information from said at least one sensor;
j) wherein said device is configured with a controllable rate of obtaining information, and wherein said device is configured with a controllable rate of transmitting information;
k) wherein said information rate is the rate at which said device monitors responses from said at least one sensor;
l) wherein said at least one sensor comprises a location component, said location component being configured to provide location information, wherein said location information provides a location of the device, and wherein said device rate of obtaining information and said device rate of transmitting information are regulated based on said location information;
m) wherein said device includes at least one other sensor for sensing a condition other than said device location, wherein said device operations of obtaining information and transmitting information are regulated by said device location provided by said device location component, and by said at least one sensor for sensing a condition other than said device location;
n) wherein said condition other than said device location is one or more of sound, motion, vibration, pressure, light, vapors, alcohol, smoke, hazardous gasses, atmospheric gasses, water, humidity, shock, magnetic fields, radiation, acceleration, impacts, position, orientation, velocity, body temperature, respiration, heart rate;
o) wherein said device is configured with a compression algorithm for compressing video captured with said device;
p) wherein said device is configured to transmit video from said device that comprises compressed video, said compressed video comprising compression based on prediction of motion;
q) wherein said device includes an image stabilizer;
r) said image stabilizer comprising at least one position sensor selected from the group consisting of IMU's, accelerometers, gyros, and gimbals, and combinations thereof, wherein said at least one position sensor is configured to provide image data for rotational and translational image correction, and wherein said video compression comprises a prediction algorithm, said processing component being configured for processing information from said at least one position sensor, wherein said compression of said video image includes a rotational and translational correction based on said position sensor image data; wherein said prediction algorithm predicts frame content based on coordinates of an image field; and wherein said position sensor movement information that is a triggering movement is subtracted from said prediction algorithm predicted movement coordinates of said frame content.

19. A portable field image recording device comprising:
a) a housing;
b) communications component for receiving and transmitting data;
c) a capture component;
d) sensor circuitry for sensing conditions at the location of said field device; wherein said sensor circuitry is configured to sense one or more conditions comprising sound, motion, vibration, pressure, light, vapors, alcohol, smoke, hazardous gasses, atmospheric gasses, water, humidity, shock, magnetic fields, radiation, acceleration, impacts, position, orientation, velocity, body temperature, respiration, and heart rate;
e) a locating feature comprising a location component for obtaining a location of said device;
f) said field device being configured to capture and transmit information that includes captured images; and
g) said field device being configured to operate in a plurality of modes, said modes including at least one of an information rate and a transmission rate, wherein said at least one of said information rate and said transmission rate are regulated by a condition sensed by said sensor circuitry;
h) wherein said information rate comprises a rate of image frames captured;
i) wherein said transmission rate comprises a rate of transmission of said captured image frames and the device location; and
j) wherein said plurality of modes includes at least one first mode where the device transmits the device location and an image comprising at least one video frame of a captured scene, and at least one second mode where the device transmits the device location and video at a rate that is greater than the rate of said first mode.

20. The device of claim 19, including:
a server computing component configured with a communications component for receiving and transmitting data between said server and said field image recording device;
wherein said field image recording device is configured to transmit information to said server component, including the location of field image recording device and captured images;
wherein said field image recording device and said server communicate with each other through a network; and
wherein said field image recording device information rate and said transmission rate are controllable by said server component.
